(19) United States
(12) Patent Application Publication
(10) Pub. No.: US 2012/0189976 A1
(43) Pub. Date: Jul. 26, 2012

(54) ORAL CARE DEVICES AND SYSTEMS

(76) Inventors: Justin E. MCDONOUGH, Flemington, NJ (US); Robert W. FUSI, II, Flemington, NJ (US); Richard J. FOUGERE, Washington Crossing, PA (US)

(21) Appl. No.: 13/353,487

(22) Filed: Jan. 19, 2012

Related U.S. Application Data
(60) Provisional application No. 61/435,862, filed on Jan. 25, 2011.

(51) Int. Cl. A61C 17/02; A61C 17/16

(52) U.S. Cl. 433/89

(57) ABSTRACT

A system and device for providing a beneficial effect to the oral cavity of a mammal, the system including means for directing a fluid effective to provide the beneficial effect onto a plurality of surfaces of the oral cavity; and the hand-held device, the hand-held device being suitable for providing the fluid to the directing means, and including means for providing reciprocation of the fluid, means for controlling the reciprocation of the fluids, means for conveying the fluid through the device system, a reservoir for containing the fluid, a power source and a linear motor.

This application claims the benefit of U.S. provisional application 61/435,862, filed Jan. 25, 2011, the complete disclosure of which is hereby incorporated herein by reference for all purposes.

### FIELD OF THE INVENTION

The present invention relates to oral care devices and systems suitable for in-home use to provide a beneficial effect to the oral cavity of a mammal.

### BACKGROUND OF THE INVENTION

In addition to regular professional dental checkups, daily oral hygiene is generally recognized as an effective preventative measure against the onset, development, and/or exacerbation of periodontal disease, gingivitis and/or tooth decay. Unfortunately, however, even the most meticulous individuals dedicated to thorough brushing and flossing practices often fail to reach, loosen and remove deep-gum and/or deep inter-dental food particulate, plaque or biofilm. Most individuals have professional dental cleanings biannually to remove tarter deposits.

For many years products have been devised to facilitate the simple home cleaning of teeth, although as yet a single device which is simple to use and cleans all surfaces of a tooth and/or the gingival or sub-gingival areas simultaneously is not available. The conventional toothbrush is widely utilized, although it requires a significant input of energy to be effective and, furthermore, a conventional toothbrush cannot adequately clean the inter-proximal areas of the teeth. Cleaning of the areas between teeth currently requires the use of floss, pick, or some such other additional device apart from a toothbrush.

Electric toothbrushes have achieved significant popularity and, although these reduce the energy input required to utilize a toothbrush, they are still inadequate to ensure proper inter-proximal tooth cleaning. Oral irrigators are known to clean the inter-proximal area between teeth. However, such devices have a single jet which must be directed at the precise inter-proximal area involved in order to remove debris. These water pump type cleaners are therefore typically only of significant value in connection with teeth having braces thereupon which often trap large particles of food. It will be appreciated that if both debris and plaque are to be removed from teeth, at present a combination of a number of devices must be used, which is extremely time consuming and inconvenient.

In addition, in order for such practices and devices to be effective, a high level of consumer compliance with techniques and/or instructions is required. The user-to-user variation in time, cleaning/treating formula, technique, etc., will affect the cleaning of the teeth.

The present invention ameliorates one or more of the above mentioned disadvantages with existing oral hygiene apparatus and methods, or at least provides the market with an alternative technology that is advantageous over known technology, and also may be used to ameliorate a detrimental condition or to improve cosmetic appearance of the oral cavity.

### SUMMARY OF THE INVENTION

The present invention includes a system for providing a beneficial effect to the oral cavity of a mammal, the system including means for directing a fluid onto a plurality of surfaces of the oral cavity, where the fluid is effective to provide the beneficial effect; and a hand-held device suitable for providing the fluid to the means for directing the fluid onto the plurality of surfaces of the oral cavity. The invention also includes the hand-held device. The hand-held device includes means for providing reciprocation of the fluid over the plurality of surfaces, means for controlling the reciprocation of the fluids, means for conveying the fluid through the system, a reservoir for containing the fluid, a power source for driving the means for providing reciprocation of the fluids; and a linear motor for driving the device and the system. The means for directing the fluid may be removably or fixedly attached to the hand-held device, or a housing containing the elements of the hand-held device.

### BRIEF DESCRIPTION OF THE DRAWINGS

FIG. 1 is a schematic drawing of an alternative embodiment of an apparatus according to the present invention;

FIG. 2 is a top front perspective view of a first embodiment of an application tray according to the present invention;

FIG. 3 is a bottom rear perspective view of the embodiment of the application tray of FIG. 2;

FIG. 4 is a vertical sectional view of the application tray of FIG. 2;

FIG. 5 is a horizontal sectional view of the application tray of FIG. 2;

FIG. 6 is a top back perspective view of a second embodiment of an application tray according to the present invention;

FIG. 7 is a top front perspective view of the embodiment of the application tray of FIG. 6;

FIG. 8 is a top view of the application tray of FIG. 6;

FIG. 9 is a cut-away view of the application tray of FIG. 6;

FIG. 10a is a back, top perspective view of an embodiment of a system according to the present invention;

FIG. 10b is a front, top perspective view of the system of FIG. 10a;

FIG. 10c is a back, top perspective view of the system of FIG. 10a, with the base station fluid reservoir attached to the base station; and

FIG. 10d is a front, top perspective view of the system of FIG. 10a, with the base station fluid reservoir attached to the base station.

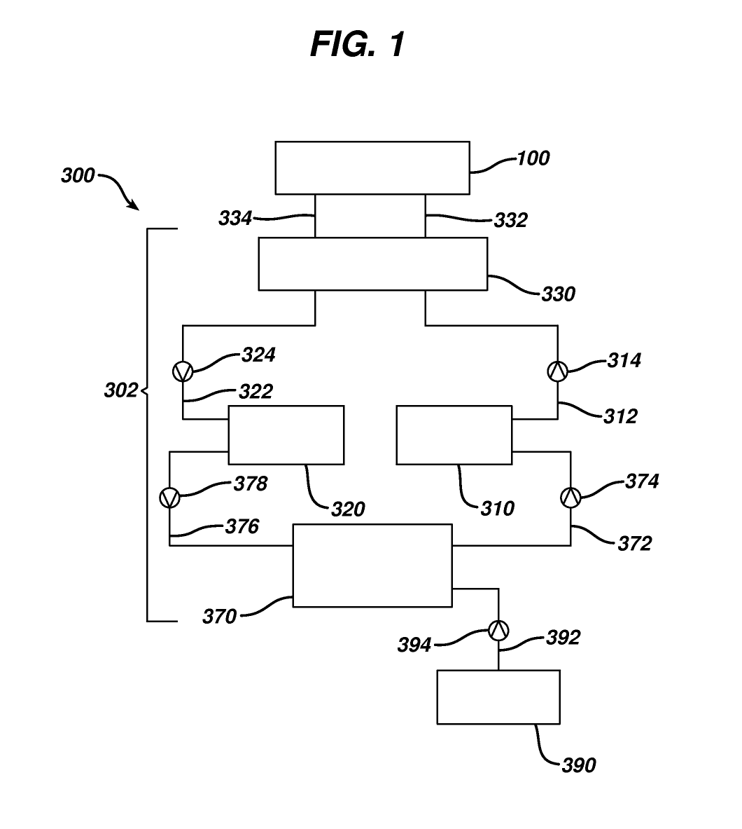

FIG. 1l a is a top perspective view of an embodiment of a hand piece according to the present invention.

FIG. 11b is a cut-away view of the hand piece of FIG. 11a.

FIG. 12a is a back, top, perspective view of a second embodiment of a hand piece according to the present invention.

FIG. 12b is a cut-away view of the hand piece of FIG. 12a.

FIG. 12c is an exploded view of the hand piece of FIG. 12a.

FIG. 12d is a back, top, exploded view of the upper section of the hand piece of FIG. 12a.

FIG. 12e is a back, bottom, exploded view of the upper section of the hand piece of FIG. 12a.

### DETAILED DESCRIPTION OF THE INVENTION

The terms “reciprocating movement of fluid(s)” and “reciprocation of fluid(s)” are used interchangeably herein. As used herein, both terms mean alternating the direction of flow of the fluid(s) back and forth over surfaces of the oral cavity of a mammal from a first flow direction to a second flow direction that is opposite the first flow direction.

By “effective fit or seal”, it is meant that the level of sealing between the means for directing fluid onto and about the plurality of surfaces in the oral cavity, e.g. an application tray, is such that the amount of leakage of fluid from the tray into the oral cavity during use is sufficiently low so as to reduce or minimize the amount of fluid used and to maintain comfort of the user, e.g. to avoid choking or gagging. Without intending to be limited, gagging is understood to be a reflex (i.e. not an intentional movement) muscular contraction of the back of the throat caused by stimulation of the back of the soft palate, the pharyngeal wall, the tonsillar area or base of tongue, meant to be a protective movement that prevents foreign objects from entering the pharynx and into the airway. There is variability in the gag reflex among individuals, e.g. what areas of the mouth stimulate it. In addition to the physical causes of gagging, there may be a psychological element to gagging, e.g. people who have a fear of choking may easily gag when something is placed in the mouth.

As used herein, “means for conveying fluid” includes structures through which fluid may travel or be transported throughout the systems and devices according to the invention and includes, without limitation passages, conduits, tubes, ports, portals, channels, lumens, pipes and manifolds. Such means for conveying fluids may be utilized in devices for providing reciprocation of fluids and means for directing fluids onto and about surfaces of the oral cavity. Such conveying means also provide fluid to the directing means and provides fluid to the reciprocation means from a reservoir for containing fluid, whether the reservoir is contained within a hand-held device containing the reciprocation means or a base unit. The conveying means also provides fluid from a base unit to a fluid reservoir contained within the hand-held device. Inventions described herein include devices and systems useful in providing a beneficial effect to an oral cavity of a mammal, e.g. a human.

Methods entail contacting a plurality of surfaces of the oral cavity with a fluid that is effective for providing the desired beneficial effect to the oral cavity. In such methods, reciprocation of the fluid(s) over the plurality of surfaces of the oral cavity is provided under conditions effective to provide the desired beneficial effect to the oral cavity. Contact of the plurality of surfaces by the fluid may be conducted substantially simultaneous. By substantially simultaneous, it is meant that, while not all of the plurality of surfaces of the oral cavity are necessarily contacted by the fluid at the same time, the majority of the surfaces are contacted simultaneously, or within a short period of time to provide an overall effect similar to that as if all surfaces are contacted at the same time.

The conditions for providing the desired beneficial effect in the oral cavity may vary depending on the particular environment, circumstances and effect being sought. The different variables are interdependent in that they create a specific velocity of the fluid. The velocity requirement may be a function of the formulation in some embodiments. For example, with change in the viscosity, additives, e.g. abrasives, shear thinning agents, etc., and general flow properties of the formulation, velocity requirements of the jets may change to produce the same level of efficacy. Factors which may be considered in order to provide the appropriate conditions for achieving the particular beneficial effect sought include, without limitation, the velocity and/or flow rate and/or pressure of the fluid stream, pulsation of the fluid, the spray geometry or spray pattern of the fluid, the temperature of the fluid and the frequency of the reciprocating cycle of the fluid.

The fluid pressures, i.e. manifold pressure just prior to exit through the jets, may be from about 0.5 psi to about 30 psi, or from about 3 to about 15 psi, or about 5 psi. Flow rate of fluid may be from about 10 ml/s to about 60 ml/s, or about 20 ml/s to about 40 ml/s. It should be noted that the larger and higher quantity of the jets, the greater flow rate required at a given pressure/velocity. Pulse frequency (linked to pulse length and delivery (ml/pulse), may be from about 0.5 Hz to about 50 Hz, or from about 5 Hz to about 25 Hz. Delivery pulse duty cycle may be from about 10% to 100%, or from about 40% to about 60%. It is noted that at 100% there is no pulse, but instead a continuous flow of fluid. Delivery pulse volume (total volume through all jets/nozzles) may be from about 0.2 ml to about 120 ml, or from about 0.5 ml to about 15 ml. Velocity of jetted pulse may be from about 4 cm/s to about 400 cm/s, or from about 20 cm/s to about 160 in/s. Vacuum duty cycle may be from about 10% to 100%, or from about 50% to 100%. It is noted that vacuum is always on at 100%. Volumetric delivery to vacuum ratio may be from about 2:1 to about 1:20, or from about 1:1 to 1:10.

Once having the benefit of this disclosure, one skilled in the art will recognize that the various factors may be controlled and selected, depending on the particular circumstances and desired benefit sought.

The fluid(s) will include at least one ingredient, or agent, effective for providing the beneficial effect sought, in an amount effective to provide the beneficial effect when contacted with the surfaces of the oral cavity. For example, the fluid may include, without limitation, an ingredient selected from the group consisting of a cleaning agent, an antimicrobial agent, a mineralization agent, a desensitizing agent, surfactant and a whitening agent. In certain embodiments, more than one fluid may be used in a single session. For example, a cleaning solution may be applied to the oral cavity, followed by a second solution containing, for example, a whitening agent or an antimicrobial agent. Solutions also may include a plurality of agents to accomplish more than one benefit with a single application. For example, the solution may include both a cleansing agent and an agent for ameliorating a detrimental condition, as further discussed below. In addition, a single solution may be effective to provide more than one beneficial effect to the oral cavity. For example, the solution may include a single agent that both cleans the oral cavity and acts as an antimicrobial, or that both cleans the oral cavity and whitens teeth.

Fluids useful for improving the cosmetic appearance of the oral cavity may include a whitening agent to whiten teeth in the cavity. Such whitening agents may include, without limitation, hydrogen peroxide and carbamide peroxide, or other agents capable of generating hydrogen peroxide when applied to the teeth. Such agents are well known within the art related to oral care whitening products such as rinses, toothpastes and whitening strips. Other whitening agents may include abrasives such as silica, sodium bicarbonate, alumina, apatites and bioglass.

It is noted that, while abrasives may serve to clean and/or whiten the teeth, certain of the abrasives also may serve to ameliorate hypersensitivity of the teeth caused by loss of enamel and exposure of the tubules in the teeth. For example, the particle size, e.g. diameter, of certain of the materials, e.g. bioglass, may be effective to block exposed tubules, thus reducing sensitivity of the teeth.

In some embodiments, the fluid may comprise an antimicrobial composition containing an alcohol having 3 to 6 carbon atoms. The fluid may be an antimicrobial mouthwash composition, particularly one having reduced ethanol content or being substantially free of ethanol, providing a high level of efficacy in the prevention of plaque, gum disease and bad breath. Noted alcohols having 3 to 6 carbon atoms are aliphatic alcohols. A particularly aliphatic alcohol having 3 carbons is 1-propanol.

In one embodiment the fluid may comprise an antimicrobial composition comprising (a) an antimicrobial effective amount of thymol and one or more other essential oils, (b) from about 0.01% to about 70.0% v/v, or about 0.1% to about 30% v/v, or about 0.1% to about 10% v/v, or about 0.2% to about 8% v/v, of an alcohol having 3 to 6 carbon atoms and (c) a vehicle. The alcohol may be 1-propanol. The fluid vehicle can be aqueous or non-aqueous, and may include thickening agents or gelling agents to provide the compositions with a particular consistency. Water and water/ethanol mixtures are the preferred vehicle.

Another embodiment of the fluid is an antimicrobial composition comprising (a) an antimicrobial effective amount of an antimicrobial agent, (b) from about 0.01% to about 70% v/v, or about 0.1% to about 30% v/v, or about 0.2% to about 8% v/v, of propanol and (c) a vehicle. The antimicrobial composition of this embodiment exhibits unexpectedly superior delivery system kinetics compared to prior art ethanolic systems. Exemplary antimicrobial agents which may be employed include, without limitation, essential oils, cetyl pyidium chloride (CPC), chlorhexidine, hexetidine, chitosan, triclosan, domiphen bromide, stannous fluoride, soluble pyrophosphates, metal oxides including but not limited to zinc oxide, peppermint oil, sage oil, sanguinaria, dicalcium dihydrate, aloe vera, polyols, protease, lipase, amylase, and metal salts including but not limited to zinc citrate, and the like. A particularly preferred aspect of this embodiment is directed to an antimicrobial oral composition, e.g. a mouthwash having about 30% v/v or less, or about 10% v/v or less, or about 3% v/v or less, of 1-propanol.

Yet another embodiment of the fluid is a reduced ethanol, antimicrobial mouthwash composition which comprises (a) an antimicrobial effective amount of thymol and one or more other essential oils; (b) from about 0.01 to about 30.0% v/v, or about 0.1% to about 10% v/v, or about 0.2% to about 8% v/v, of an alcohol having 3 to 6 carbon atoms; (c) ethanol in an amount of about 25% v/v or less; (d) at least one surfactant; and (e) water. Preferably the total concentration of ethanol and alcohol having 3 to 6 carbon atoms is no greater than 30% v/v, or no greater than 25% v/v, or no greater than 22% v/v.

In still another embodiment, the fluid is an ethanol-free antimicrobial mouthwash composition which comprises (a) an antimicrobial effective amount of thymol and one or more other essential oils; (b) from about 0.01% to about 30.0% v/v, or about 0.1% to about 10% v/v, or about 0.2% to about 8%, of an alcohol having 3 to 6 carbon atoms; (c) at least one surfactant; and (d) water.

The alcohol having 3 to 6 carbon atoms is preferably selected from the group consisting of 1-propanol, 2-propanol, 1-butanol, 2-butanol, tert-butanol and corresponding diols. 1-Propanol and 2-propanol are preferred, with 1-propanol being most preferred.

In addition to generally improving the oral hygiene of the oral cavity by cleaning, for example, removal or disruption of plaque build-up, food particles, biofilm, etc., the inventions are useful to ameliorate detrimental conditions within the oral cavity and to improve the cosmetic appearance of the oral cavity, for example whitening of the teeth. Detrimental conditions may include, without limitation, caries, gingivitis, inflammation, symptoms associated with periodontal disease, halitosis, sensitivity of the teeth and fungal infection. The fluids themselves may be in various forms, provided that they have the flow characteristics suitable for use in devices and methods of the present invention. For example, the fluids may be selected from the group consisting of solutions, emulsions and dispersions. In certain embodiments, the fluid may comprise a particulate, e.g. an abrasive, dispersed in a fluid phase, e.g. an aqueous phase. In such cases, the abrasive would be substantially homogeneously dispersed in the aqueous phase in order to be applied to the surfaces of the oral cavity. In other embodiments, an oil-in-water or water-in-oil emulsion may be used. In such cases, the fluid will comprise a discontinuous oil phase substantially homogeneously dispersed within a continuous aqueous phase, or a discontinuous aqueous phase substantially homogenously dispersed in a continuous oil phase, as the case may be. In still other embodiments, the fluid may be a solution whereby the agent is dissolved in a carrier, or where the carrier itself may be considered as the agent for providing the desired beneficial effect, e.g., an alcohol or alcohol/water mixture, usually having other agents dissolved therein.

The present invention includes devices, e.g. an oral hygiene device, for example a dental cleaning apparatus, suitable for in-home use and adapted to direct fluid onto a plurality of surfaces of a tooth and/or the gingival area. In certain embodiments the surfaces of the oral cavity are contacted by the fluid substantially simultaneously. As used herein, reference to the gingival area includes, without limitation, reference to the sub-gingival pocket. The appropriate fluid is directed onto a plurality of surfaces of teeth and/or gingival area substantially simultaneously in a reciprocating action under conditions effective to provide cleaning, and/or general improvement of the cosmetic appearance of the oral cavity and/or amelioration of a detrimental condition of the teeth and/or gingival area, thereby providing generally improved oral hygiene of teeth and/or gingival area. For example, one such device cleans teeth and/or the gingival area and removes plaque using an appropriate cleaning fluid by reciprocating the fluid back and forth over the front and back surfaces and inter-proximal areas of the teeth, thereby creating a cleaning cycle while minimizing the amount of cleaning fluid used.

Devices of the invention that provide reciprocation of the fluid comprise a means for controlling reciprocation of the fluid. The controlling means include means for conveying the fluid to and from a means for directing the fluid onto the plurality of surfaces of the oral cavity. In certain embodiments, the means for providing reciprocation of the fluid comprises a plurality of portals for receiving and discharging the fluid, a plurality of passages, or conduits, through which the fluid is conveyed, and means for changing the direction of flow of the fluid to provide reciprocation of the fluid, as described in more detail herein below. The controlling means may be controlled by a logic circuit and/or a mechanically controlled circuit.

In certain embodiments, devices for providing reciprocation may include a means for attaching or connecting the device to a reservoir for containing the fluid. The reservoir may be removably attached to the device. In this case, the reservoir and the device may comprise means for attaching one to the other. After completion of the process, the reservoir may be discarded and replaced with a different reservoir, or may be refilled and used again. In other embodiments, the reciprocating device will include a reservoir integral with the device. In embodiments where the device may be attached to a base unit, as described herein, the reservoir, whether integral with the device or removably attached to the device, may be refilled from a supply reservoir which forms a part of the base unit. Where a base unit is utilized, the device and the base unit will comprise means for attaching one to the other.

The device will comprise a power source for driving the means for reciprocating fluids. The power source may be contained within the device, e.g. in the handle of the device, for example, batteries, whether rechargeable or disposable. Where a base unit is employed, the base may include means for providing power to the device. In other embodiments, the base unit may include means for recharging the rechargeable batteries contained within the device.

Devices for providing reciprocation of fluids will include means for attaching the device to means for directing the fluid onto the plurality of surfaces of the oral cavity, e.g. an application tray or mouthpiece. In certain embodiments, the directing means provides substantially simultaneous contact of the plurality of surfaces of the oral cavity by the fluid. The attachment means may provide removable attachment of the mouthpiece to the device. In such embodiments, multiple users may use their own mouthpiece with the single device comprising the reciprocating means. In other embodiments, the attachment means may provide a non-removable attachment to the mouthpiece, whereby the mouthpiece is an integral part of the device. Devices for providing reciprocation as described above may be contained within a housing with other device components so as to provide a hand-held device suitable for providing fluid to the directing means, as described herein below.

The means for directing the fluid onto the surfaces of the oral cavity, e.g. an application tray or mouthpiece, is comprised of multiple components. The directing means comprises a chamber for maintaining the fluid proximate the plurality of surfaces, i.e. fluid-contacting-chamber (LCC). By “proximate”, it is meant that the fluid is maintained in contact with the surfaces. The LCC is defined by the space bounded by the front inner wall and rear inner wall of the mouthpiece, and a wall, or membrane, extending between and integral with the front and rear inner walls of the mouthpiece, and in certain embodiments, a rear gum-sealing membrane. Together, the front and rear inner walls, the wall extending there between and rear gum-sealing membrane form the LCCM (LCCM). The general shape of the LCCM is that of a “U” or an “n”, depending on the orientation of the mouthpiece, which follows the teeth to provide uniform and optimized contact by the fluid. The LCCM may be flexible or rigid depending on the particular directing means. The membrane may be located as a base membrane of the LCCM. The front and rear inner walls of the LCCM each include a plurality of openings, or slots, through which the fluid is directed to contact the plurality of surfaces of the oral cavity.

The LCCM design may be optimized for maximum effectiveness as it relates to the size, shape, thickness, materials and volume created around the teeth/gingiva, nozzle design and placement as it relates to the oral cavity and the teeth in conjunction with the manifold and gingival margin seal to provide comfort and minimize the gagging reflex of the user. The combination of the above provides effective contact of the teeth and gingival area by the fluid.

The LCCM provides a controlled and isolated environment with known volume, i.e. the LCC, to contact teeth and/or gingival area with fluids, and then to remove spent fluids, as well as debris, plaque, etc., from the LCC without exposing the whole oral cavity to fluid, debris, etc. This decreases the potential for ingestion of the fluids. The LCCM also allows increased flow rates and pressure of fluids without drowning the individual nozzles when significant flow rates are required to provide adequate cleaning, for example. The LCCM also allows reduced fluid quantities and flow rates when required, as only the area within the LCC is being contacted with fluid, not the entire oral cavity. The LCCM also allows controlled delivery and duration of contact of fluid on, through and around teeth and the gingival area, allowing increased concentrations of fluids on the area being contacted by the fluid, thereby providing more effective control and delivery of fluid.

The LCCM may also allow controlled sampling of the oral cavity due to precise positioning of the mouthpiece in the oral care cavity for use in detection or diagnostics. It can also provide capability to take image and/or diagnose gum health through a variety of methods. The system also provides the ability to expand functionality for cleaning and/or treating other oral cavity areas such as, but not limited to, the tongue, cheeks, gingival, etc.

The thickness of the walls of the LCCM may be within a range of 0.2 mm to 1.5 mm, to provide necessary physical performance properties, while minimizing material content, and optimizing performance. The distance between the inner walls of the LCCM to the teeth may be from about 0.1 mm to about 5 mm, and more typically an average distance of about 2.5 mm to provide maximum comfort, while minimizing customization and LCC volume requirements.

The size and shape of the mouthpiece preferably utilizes three basic universal sizes (small, medium and large) for both the top and bottom teeth, but the design provides mechanisms to allow different levels of customization as required to ensure comfort and functionality to the individual user. The device may incorporate a switching mechanism, which would allow it to be operable only when in the correct position in the mouth. The mouthpiece may include both upper and lower sections to provide substantially simultaneous contact of the plurality of surfaces of the oral cavity by fluid. In an alternate embodiment the upper and lower sections may be cleaned utilizing a single bridge that could be used on the upper or lower teeth and gums of the user (first placed on one portion for cleaning, then subsequently placed over the other portion for cleaning).

The number and location of openings, also referred to herein as slots, jets or nozzles, contained within the inner walls of the mouthpiece through which the fluid is directed will vary and be determined based upon the circumstances and environment of use, the particular user and the beneficial effect being sought. The cross-sectional geometry of the openings may be circular, elliptical, trapezoidal, or any other geometry that provides effective contact of the surfaces of the oral cavity by the fluid. The location and number of openings may be designed to direct jets of fluid in a variety of spray patterns effective for providing the desired beneficial effect. Opening diameters may be from about 0.1 to about 3 mm, or from about 0.2 mm to about 0.8 mm, or about 0.5 mm, to provide effective cleaning and average jet velocities and coverage.

Optimal opening placement and direction/angles allows coverage of substantially all teeth surfaces in the area if the oral cavity to be contacted by fluid, including but not limited to interdental, top, side, back, and gingival pocket surfaces. In alternate embodiments, the openings could be of different sizes and different shapes to provide different cleaning, coverage and spray patterns, to adjust velocities, density and fan patterns (full cone, fan, partial, cone, jet), or due to formulation consideration. Nozzles could also be designed to be tubular and or extend from the LCCM to provide directed spray, or act as sprinkler like mechanism to provide extended coverage across the teeth, similar to a hose sprinkler system. The nozzles are preferably integral to the inner walls of the LCCM and can be incorporated into the inner walls through any number of assembly or forming techniques known in the art (insert molded, formed in membrane through machining, injection molding, etc.).

The LCCM may be an elastomeric material such as ethylene vinyl acetate (EVA), thermoplastic elastomer (TPE), or silicone, to allow motion of the inner walls and provide a greater jet coverage area with minimal mechanics, reducing the volumetric flow requirements to achieve optimized performance, while providing a softer and more flexible material to protect the teeth if direct contact with the teeth is made. A flexible membrane may also provide acceptable fitment over a large range of users, due to its ability to conform to the teeth. Alternatively, the LCCM could be made of a rigid or semi-rigid material, such as but not limited to a thermoplastic.

It may be desirable, although not required, to have motion of the LCCM relative to the teeth. In some embodiments, motion of the LCCM is provided through pressurization, pulsation, and movement of fluid through the manifolds. In alternate embodiments, this motion can be achieved through vibration, sonic, or ultrasonic mechanism. This motion can also be provided through a separate network of tubes and/manifolds constructed within or attached to the LCC, which can be charged or discharged with fluid and/or air to create a desired motion of the membrane. In addition, motion of the LCCM may be the result of the motion of the user's jaw or teeth.

In an alternate embodiment, the LCCM motion system can also include mechanically moving the LCCM via a track-like guided reciprocating motion, the track being created by the teeth. In another alternate embodiment, the desired LCCM motion can be created by using one or a multiple of linear motor systems, which allow sequential motion via multiple permanent magnet/coil pairs located in strategic locations on the mouthpiece to provide optimized cleaning and treatment sequences for directing jets and cleaning elements. In yet another alternative embodiment, motion may be created by shape memory materials or piezoelectrics.

In an alternate embodiment, the LCCM could also include abrasive elements such as filaments, textures, polishing elements, additives (silica, etc.), and other geometric elements that could be used for other cleaning and/or treatment requirements as well as ensuring minimal distance between the teeth and LCCM for, but not limited to, treatment, cleaning, and positioning.

In some embodiments, the LCCM may contain a sensing device and/or switch, which determines if the mouthpiece is in the correct position over the teeth in the oral cavity and which will not allow the device to activate unless this position is verified through the switch/sensor. Also, if the mouthpiece is moved or dislodged from this position during use, it will immediately stop functioning. An override switch can be incorporated during application tray cleaning.

The LCCM could be created via a variety of methods such as, but not limited to, machining, injection molding, blow molding, extrusion, compression molding, and/or vacuum forming. It can also be created in conjunction with the manifold, but incorporating the manifold circuitry within the LCC, and/or over-molded onto the manifold to provide a unitary construction with minimal assembly.

In one embodiment, the LCCM may be fabricated separately and then assembled to the manifolds, utilizing any number of assembling and sealing techniques, including adhesives, epoxies, silicones, heat sealing, ultrasonic welding, and hot glue. The LCCM is designed in a way that, when assembled with the manifold, it effectively and efficiently creates the preferred dual manifold design without any additional components.

In certain embodiments, the LCCM can also be designed or used to create the gingival sealing area. In certain embodiments, a vacuum is applied within the LCC, which improves the engagement of the mouthpiece to form a positive seal with the gingival in the oral cavity. In other embodiments, a pressure is applied outside the LCCM, within the oral cavity, which improves the engagement of the mouthpiece to form a positive seal with the gingival in the oral cavity. In yet other embodiments, a denture-like adhesive may be applied around the mouthpiece during the initial use to provide a custom reusable resilient seal when inserted into the oral cavity for a particular user. It would then become resiliently rigid to both conform and provide a positive seal with the guns and on subsequent applications. In another embodiment, the seal could be applied and/or replaced or disposed of after each use.

The directing means also comprises a first manifold for containing the fluid and for providing the fluid to the LCC through the openings of the front inner wall, and a second manifold for containing the fluid and for providing the fluid to the chamber through the openings of the rear inner wall. This design provides a number of different options, depending on what operation is being conducted. For instance, in a cleaning operation, it may be preferable to deliver jets of fluid into the LCC directly onto the teeth from one side of the LCC from the first manifold and then evacuate/pull the fluid around the teeth from the other side of the LCC into the second manifold to provide controlled interdental, gumline and surface cleaning. This flow from the one side of the LCC could be repeated a number of times in a pulsing action before reversing the flow to deliver jets of fluid from the second manifold and evacuating/pulling the fluid through the back side of the teeth into the first manifold for a period of time and/or number of cycles. Such fluid action creates a turbulent, repeatable and reversible flow, thus providing reciprocation of the fluid about the surfaces of the oral cavity.

In a treatment, pre-treatment, or post-treatment operation it may be preferable to deliver the fluid through one or both manifolds simultaneously, flooding the chamber and submerging the teeth for a period of time and then evacuating the chamber after a set period of time through one or both manifolds.

In alternate embodiments, the manifold can be of single manifold design providing pushing and pulling of the fluid through the same sets of jets simultaneously, or can be any number of manifold divisions to provide even greater control of the fluid delivery and removal of the cleaning and fluid treatment. In the multi-manifold also can be designed to have dedicated delivery and removal manifolds. The manifolds can also be designed to be integral to and/or within the LCCM.

The material for the manifold would be a semi-rigid thermoplastic, which would provide the rigidity necessary not to collapse or burst during the controlled flow of the fluids, but to provide some flexibility when fitting within the user's mouth for mouthpiece insertion, sealing/position and removal. To minimize fabrication complexity, number of components and tooling cost, the dual manifold is created when assembled with the LCCM. The manifold could also be multi-component to provide a softer external “feel” to the teeth/gums utilizing a lower durometer elastomeric material, such as, but not limited to, a compatible thermoplastic elastomer (TPE). The manifold could be created via a variety of methods such as, but not limited to machining, injection molding, blow molding, compression molding, or vacuum forming.

The directing means also comprises a first port for conveying the fluid to and from the first manifold and a second port for conveying the fluid to and from the second manifold, and means for providing an effective seal of the directing means within the oral cavity, i.e. a gingival seal. In certain embodiments, the first and second ports may serve both to convey fluid to and from the first and second manifolds and to attach the mouthpiece to the means for providing fluid to the mouthpiece. In other embodiments, the directing means may further include means for attaching the directing means to means for providing fluid to the directing means.

FIG. 1 is a schematic drawing of an embodiment of a method and system according to the present invention. The figure shows system 300, with components including: means for providing reciprocation of fluid in the oral cavity 302, fluid reservoir 370, fluid supply reservoir 390, and means for directing fluid onto and about the plurality of surfaces in the oral cavity, in this instance shown as application tray 100. Means for providing reciprocation of fluids may include delivery device 310, collection device 320, reciprocating flow controller 330, tubes 312, 322, 372, 376, and 392, and solution one-way flow valves 314, 324, 374, 378, and 394. Tubes 332 and 334 provide for conveyance of the fluid from reciprocating flow controller 330 to application tray 100.

In some embodiments, delivery device 310 and collection device 320 may be individual, single action piston pump. In other embodiments, delivery device 310 and collection device 320 may be housed together as a dual action piston pump. Fluid supply reservoir 390 and fluid reservoir 370 may be made of glass, plastic or metal. Fluid supply reservoir 390 may be integral to system 300 and refillable. In some embodiments, fluid supply reservoir 390 may be a replaceable fluid supply, detachably connected to system 300.

In some embodiments, any of fluid supply reservoir 390, fluid reservoir 370, or tubes 312, 372, 392, may include a heat source to pre-warm fluid prior to direction into application tray 100 for application to the plurality of surfaces in the oral cavity. The temperature should be maintained within a range effective to provide comfort to the user during use.

Application tray 100, could be integral with, or detachably connected to cleaning reciprocating means 302 by way of tubes 332, 334, and other attachment means (not shown).

Fluid in fluid supply reservoir 390 flows through tube 392 to fluid reservoir 370. Fluid in reservoir 370 flows through tube 372 to delivery device 310. Fluid flow through tube 372 may be controlled by one-way flow valve 374. From delivery device 310, fluid flows through tube 312 to reciprocating flow controller 330. One-way flow valve 314 controls the fluid flow through tube 312. Fluid flows from reciprocating flow controller 330 to application tray 100 through tube 332 or 334, depending on the flow direction setting of flow controller 330. Fluid flows from application tray 100, through tube 334 or 332 back to reciprocating flow controller 330, and from reciprocating flow controller 330 to collection device 320, through tube 322. One-way flow valve 324 controls the fluid flow through tube 322. Finally, cleaning fluid flows from collection device 320 to fluid reservoir 370 through tube 376. One-way flow valve 378 controls the fluid flow through tube 376.

The actions of delivery device 310 and collection device 320 are controlled by a logic circuit, which may include a program to the start of the reciprocation cycle, a program to execute the reciprocation cycle, i.e. to cause solution to be reciprocated about the plurality of surfaces of the oral cavity, thereby providing the beneficial effect, a program to empty application tray 100 at the end of the reciprocation cycle, and a self-cleaning cycle to clean the system between uses, or at pre-set or automatic cleaning times.

System 300 may also include switches such as on/off, fill application tray 100, run the cleaning program, empty system 300, and clean system 300, and indicator, or display, lights including, but are not limited to, power on, charging, cycle program running, device emptying, results or feedback, and self-cleaning cycle in operation. In embodiments where fluid is pre-warmed prior to direction into application tray 100, a display light could be used to indicate that the fluid is at the proper temperature for use.

One method of using system 300 to clean teeth is as follows. Prior to use, cleaning fluid in fluid supply chamber 390 flows through tube 392 and one-way valve 394 to cleaning fluid reservoir 370. In some embodiments, fluid supply reservoir 390 is now disconnected from system 300.

In the first step, the user positions application tray 100 in the oral cavity about the teeth and gingival area. The user closes down on tray 100, thereby achieving an effective fit or seal between gums, teeth and tray 100. The user pushes a start button initiating the cleaning process. The cleaning process is as follows:
1. Delivery device 310 is activated to begin drawing cleaning fluid from cleaning fluid reservoir 370 through tube 372 and one-way flow valve 374.
2. Once delivery device 310 is sufficiently filled, delivery device 310 is activated to begin dispensing cleaning fluid to application tray 100 via tube 312, one-way valve 314, reciprocating flow controller 330, and tube 332.
3. Collection device 320 is activated sequentially to, or simultaneously with, activation of delivery device 310 to begin drawing cleaning fluid from application tray 100 via tube 334, reciprocating flow controller 330, tube 322, and one-way valve 324. Cleaning solution will be prevented from flowing through tube 372 by one-way flow valve 374. In some embodiments, delivery device 310 and collection device 320 are controlled by a logic circuit to work in concert so that an equal volumetric flow of cleaning fluid is dispensed from delivery device 310 and drawn into collection device 320.
4. Collection device 320 is activated to begin dispensing cleaning solution to cleaning fluid reservoir 370 via tube 376 and one-way valve 378. Cleaning fluid will be prevented from flowing through tube 322 by one-way flow valve 324. Delivery device 310 is also activated to begin drawing cleaning fluid from cleaning fluid reservoir 370 through tube 372 and one-way flow valve 374.
5. To reciprocate the cleaning fluid, steps 2 and 3 are repeated after the flow direction is reversed, cycling cleaning fluid between delivery/collection device 320 and application tray 100, using tubes 334 and 332, respectively.
6. To cycle cleaning fluid, steps 2 through 4 are repeated, cycling cleaning fluid between cleaning fluid reservoir 370 and application tray 100
7. The process continues to run until the time required for cleaning has expired, or the desired numbers of cycles are complete.

It is important to note that this sequence can be repeated indefinitely with additional supplies of fluid in the respective supply reservoirs. In addition, the final fluid supply reservoir may contain water or other cleaning fluids and the system may be purged for cleaning.

The oral hygiene system may be comprised of several major components including, but not limited to, a base station, a hand piece for containing means for providing reciprocation of fluid about the plurality of surfaces within the oral cavity, and the application tray, or mouthpiece. The system is suitable for in-home use and adapted to direct fluid onto a plurality of surfaces of a tooth simultaneously. The device cleans teeth and removes plaque using cleaning solution that is reciprocated back and forth creating a cleaning cycle and minimizing cleaning solution used. The device could be hand held, or may be in the form of a table or counter-top device.

The base station will charge a rechargeable battery in the hand piece, hold fluid reservoirs, house diagnostic components, provide feedback to the user, and potentially clean the mouthpiece.

The hand piece will have a powered pump that will deliver fluid from the reservoir to the mouthpiece. The direction of flow may be reciprocated with fluid control valving, by a specialized pump (reversing its direction, etc), reversible check valves, or other similar means. The cycle time and flow velocity for each stage of the cycle will be variable and in some embodiments, be customized to each individual user. The hand piece will perform a filling process, and a cleaning and/or purging process. The hand piece and/or base station may provide feedback to the user for each stage of the process and potentially report diagnostic information.

The hand piece will be aesthetically pleasing and have a grip/feel comfortable for the user's hand. The weight and balance will be well suited to comfortable and efficient use while giving a high quality feel. Finger grips and/or touch points will be appropriately located for comfort, grip, feel, and assistance in proper orientation and grip location of the hand piece. The base station will also be aesthetically pleasing and allow the hand piece to easily and securely dock into position. The base station may or may not lock the hand piece into position once it's docked.

The third major component of the apparatus is the application tray, or mouthpiece.

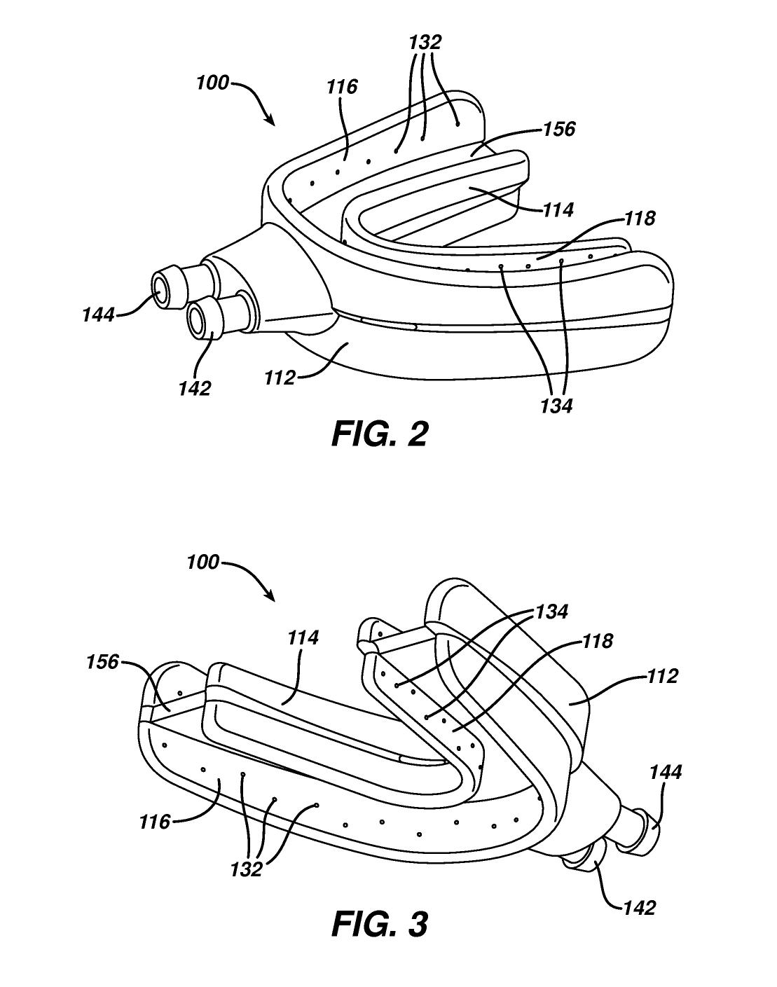

FIG. 2 is a top perspective view of a first embodiment of means for directing fluid onto a plurality of surfaces in the oral cavity, e.g. an application tray 100, according to the present invention. FIG. 3 is a bottom perspective view of the application tray 100 of FIG. 2. The figures show application tray 100 with outer front wall 112, outer back wall 114, inner front wall 116, inner back wall 118, and base membrane, e.g. bite plate, 156. Inner front wall jet slots 132 are located on inner front wall 116, while inner back wall jet slots 134 are located on inner back wall 118. The inner front wall jet slots 132 and inner back wall jet slots 134 shown in FIGS. 2 and 3 are only one embodiment of jet slot configuration. First port 142 and second port 144 enter application tray 100 through outer front wall 112.

FIGS. 2 and 3 depict an embodiment of an application tray 100 in which the user's top and bottom teeth and/or gingival area are substantially simultaneously contacted with fluid to provide the desired beneficial effect. It should be understood that in other embodiments, application tray 100 may be designed to clean and/or treat only the top or bottom teeth and/or gingival area of the user.

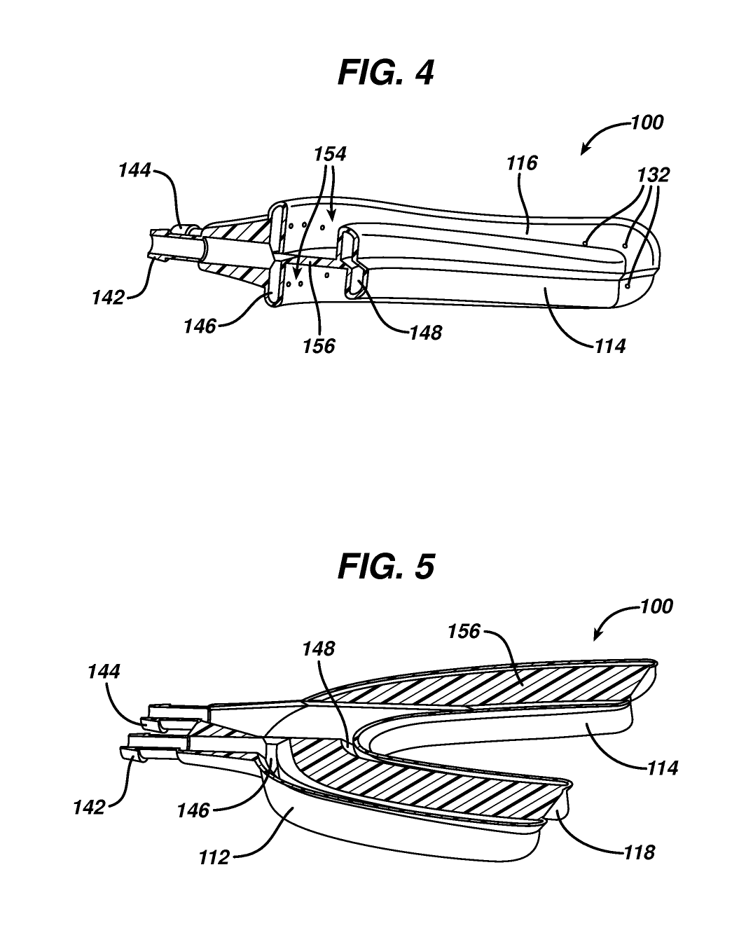

FIGS. 4 and 5 are vertical and horizontal, respectively, sectional views of the application tray 100 of FIG. 2. The figures show first manifold 146, defined as the space bordered by outer front wall 112 and inner front wall 116. Second manifold 148 is defined as the space bordered by outer back wall 114 and inner back wall 118. The fluid-contacting chamber (LCC) 154 is defined by inner front wall 116, inner back wall 118, and base membrane 156.

In one embodiment of a operation, fluid enters first manifold 146 through first port 142 by pressure and then enters LCC 154 through inner front wall jet slots 132. A vacuum is pulled on second port 144 to pull the fluid through inner back wall jet slots 134, into second manifold 148 and finally into second port 144. In this embodiment, jets of fluid are first directed onto the front surfaces of the teeth and/or gingival area from one side of the LCC 154, directed through, between, and around the surfaces of the teeth and/or gingival area from the other side of LCC 154 into the second manifold to provide controlled interdental, gumline, surface and/or gingival area cleaning or treatment. Next, the flow in the manifolds is reversed. Cleaning fluid enters second manifold 148 through second port 144 by pressure and then enters LCC 154 through inner back wall jet slots 134. A vacuum is pulled on first port 142 to pull the fluid through inner front wall jet slots 132, into first manifold 146 and finally into first port 142. In the second portion of this embodiment, jets of fluid are directed onto the back surfaces of the teeth and/or gingival area, and directed through, between, and around the surfaces of the teeth and/or gingival area. The alternating of pressure/vacuum through a number of cycles creates a turbulent, repeatable and reversible flow to provide reciprocation of fluid about the plurality of surfaces of the oral cavity to substantially simultaneously contact the surfaces of the oral cavity with fluid, thereby providing the desired beneficial effect.

In another embodiment it may be preferable to deliver the fluid through one or both manifolds simultaneously, flooding LCC 154, submerging the teeth for a period of time and then evacuating the LCC 154 after a set period of time through one or both manifolds. Here, cleaning or treating fluid simultaneously enters first manifold 146 through first port 142, and second manifold 148 through second port 144 by pressure and then enters LCC 154 simultaneously through inner front wall jet slots 132 and inner back wall jet slots 134. To evacuate LCC 154, a vacuum is simultaneously pulled on first manifold 146 through first port 142, and second manifold 148 through second port 144. Cleaning or treatment fluid is pulled through inner front wall jet slots 132 and inner back wall jet slots 134, into first manifold 146 and second manifold 148.

It is also possible to deliver different fluid compositions to first manifold 146 and second manifold 148. The different fluid compositions could then combine in the LCC for improved cleaning efficacy or treatment effects.

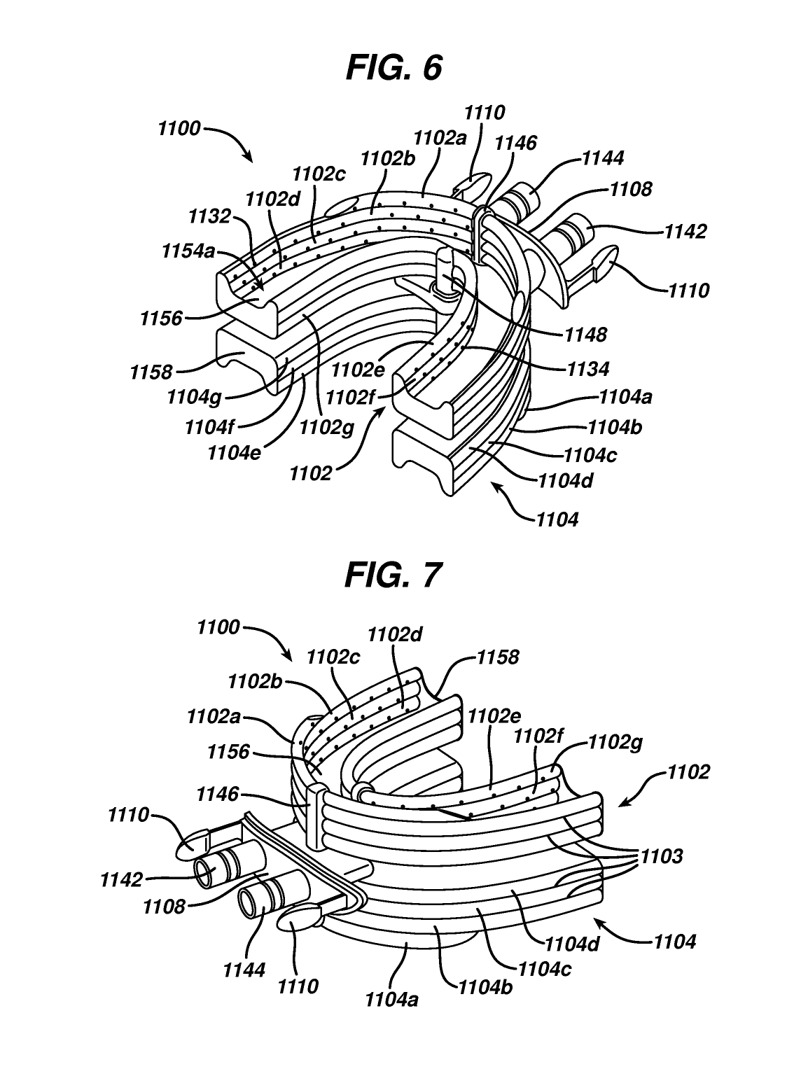

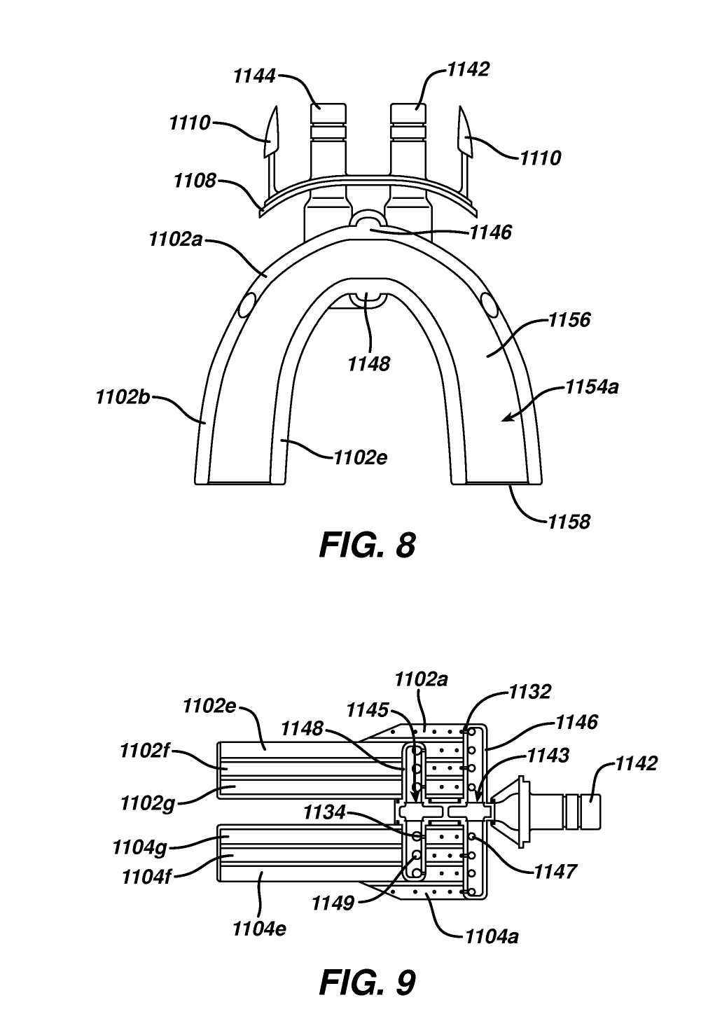

FIG. 6 is a top, rear perspective view of a second embodiment of an application tray 1100 according to the present invention. FIG. 7 is a top, front perspective view of the application tray 1100 of FIG. 6, while FIG. 8 is a top view of the application tray of FIG. 6. The figures show application tray 1100 with top piece 1102, bottom piece 1104, first port 1142, second port 1144, and support plate 1108 fixedly attached to the front of said application tray. First port 1142 and second port 1144 enter application tray 1100 and extend through support plate 1108.

Optional quick disconnect structures, e.g. barbs, 1110 are attached to support plate 1108, allowing application tray 1100 to be quickly and easily attached to and then disconnected from means for providing fluid to the application tray. The housing would include structure effective to receive such quick disconnect barbs, or similar quick disconnect structure, in attachable engagement, to detachably connect the application tray to the housing. The quick disconnect option could be used to replace used or worn application trays, or to change application trays for different users. In some embodiments, a single user may change application trays to change the flow characteristics for different options, such as number of cleaning nozzles, nozzle velocity, spray pattern, and locations, coverage area, etc.

FIGS. 6 to 9 depict an embodiment of an application tray 1100 in which the user's top and bottom teeth and/or gingival area are substantially simultaneously contacted with fluid. It should be understood that in other embodiments, application tray 1100 may be designed to contact only the top or bottom teeth or gingival area of the user with fluid.

Top piece 1102 has front fluid lumens 1102a, 1102b, 1102c, and 1102d, back fluid lumens 1102e, 1102f, and 1102g, first manifold 1146, second manifold 1148, base membrane 1156, and back gum-sealing membrane 1158. Front fluid lumens 1102a, 1102b, 1102c, and 1102d are all connected by first manifold 1146, and optionally (as shown on FIGS. 16 to 19), connected to each other along all, or part of, their length. Likewise, back fluid lumens 1102e, 1102f, and 1102g, are all connected by second manifold 1148, and optionally, connected to each other along all, or part of, their length.

Bottom piece 1104, may be a mirror image of top piece 1102, and has front fluid lumens 1104a, 1104b, 1104c, and 1104d, back fluid lumens 1104e, 1104f, and 1104g, first manifold 1146, second manifold 1148, base membrane 1156, and back gum-sealing membrane 1158. Front fluid lumens 1104a, 1104b, 1104c, and 1104d are all connected by first manifold 1146, and optionally (as shown on FIGS. 6 to 9), connected to each other along all, or part of, their length. Likewise, back fluid lumens 1104e, 1104f, and 1104g, are all connected by second manifold 1148, and optionally, connected to each other along all, or part of, their length.

Though FIGS. 6 and 7 show top piece 1102 with four front fluid lumens (1102a, 1102b, 1102c, and 1102d) and three back fluid lumens (1102e, 1102f, and 1102g), top piece 1102 may also be formed with two, three, five, six, or even seven front or back fluid lumens. Likewise, bottom piece 1104 is shown with four front fluid lumens (1104a, 1104b, 1104c, and 1104d) and three back fluid lumens (1104e, 1104f, and 1104g), bottom piece 1104 may also be formed with two, three, five, six, or even seven front or back fluid lumens.

The fluid-contacting chamber ((LCC) 1154a, mentioned above, is located in top piece 1102, defined by front fluid lumens (1102a, 1102b, 1102c, and 1102d), back fluid lumens (1102e, 1102f, and 1102g), base membrane 1156, and back gum-sealing membrane 1158. Though not shown, bottom piece 1104 also has a LCC 1154b, defined by front fluid lumens (1104a, 1104b, 1104c, and 1104d), back fluid lumens (1104e, 1104f, and 1104g), base membrane 1156, and back gum-sealing membrane 1158.

The multi-lumen design provides bidirectional or dedicated lumens for flow and vacuum that are self-reinforcing and therefore do not collapse under vacuum or rupture under pressure while in use, maximizing the structural integrity, while minimizing the size of the overall application tray 1100 for user comfort during insertion, in-use, and upon removal. This decreased size also serves to provide an enhanced effective seal of the application tray in the oral cavity.

If the multiple lumens (1102a, 1102b, 1102c, 1102d, 1102e, 1102f, 1102g, 1104a, 1104b, 1104c, 1104d, 1104e, 1104f, and 1104g) are connected as described above, they form a lumen hinge sections (1103 on FIG. 7). This may result in the multi-lumen design providing conformance in the X, Y and Z directions, due to the flexibility of lumen hinge sections 1103 between each lumen. This design allows effective and feasible conformance to a variety of different users teeth and gum topography, providing the effective gum sealing without irritating the gums and allowing dynamic positioning of the fluid cleaning jets around each of the teeth to obtain proximal and interdental cleaning action. The multiple lumens are also attached to the first manifold 1146 and second manifold 1148. This creates a secondary flexible joint providing two additional degrees of motion for the adjusting to different bite architectures that may be encountered.

The back gum-sealing membrane 1158 proves a flexible and universal sealing mechanism to minimize leakage into the oral cavity while redirecting flow onto and around teeth, to maximize treatment/cleaning area to get to hard-to-reach-places (HTRP). The membrane can provide an elastic function across the lumen longitudinal axis to form around the teeth and gums.

Base membrane 1156 provides the flexibility required for effective fit or sealing within the oral cavity and allowing redirection and flow of jets back towards the teeth and/or gingival surfaces.

Optionally, application tray 1100 could also include gum-sealing component if required, which could be attached to the front fluid lumens 1102a, 1102b, 1104a, and 1104b, and back fluid lumens 1102e and 1104e (member furthest from teeth).

Optionally, frictional elements, such as filament tufts, could also be placed or secured through any of the lumen hinge sections 1103 without significantly increasing the size of application tray 1100, or impacting user comfort or fluid flow in the application tray 1100.

Inner front wall jet slots 1132 are located on inner front wall of top piece 1102 and bottom piece 1104, while inner back wall jet slots 1134 are located on inner back wall of top piece 1102 and bottom piece 1104. Though only one inner front wall jet slot 1132 and inner back wall jet slot 1134 are shown in FIGS. 13 to 16, the number, shape and size of inner front wall jet slots 1132 and inner back wall jet slots 1134 affect the cleaning of the teeth and gums, and can be designed to direct jets of cleaning fluid in a variety of spray patterns. The inner front wall jet slots 1132 and inner back wall jet slots 1134 shown in FIGS. 16 to 19 are only one embodiment of jet slot configuration.

FIGS. 6 and 7 depict an embodiment of an application tray 1100 in which surfaces of the users top and bottom teeth and/or gingival area are substantially simultaneously contacted by fluid to provide the desired beneficial effect. It should be understood that, in other embodiments, application tray 1100 may be designed to contact only the top or bottom teeth and/or gingival area of the user.

FIG. 9 is a cut-away view of the application tray 1100 of FIG. 6. The figure shows first manifold 1146 and second manifold 1148. In one embodiment of a cleaning operation, cleaning fluid is pumped through first port 1142, and enters first manifold 1146 through first flow diverter 1143. Fluid enters front fluid lumens 1102a, 1102b, 1102c, 1102d, 1104a, 1104b, 1104c and 1104d through front fluid lumen ports 1147. The cleaning fluid then enters LCCs 1154a and 1154b through inner front wall jet slots 1132. A vacuum is pulled on second port 1144 to pull the cleaning fluid through inner back wall jet slots 1134, into back fluid lumens 1102e, 1102f, 1102g, 1104e, 1104f, and 1104g. The fluid enters second manifold 1148 through back fluid lumen ports 1149, then through second flow diverter 1145, and finally into second port 1144.

In this embodiment, jets of cleaning fluid are first directed from first manifold 1146 to the front surfaces of the teeth and/or gingival area from one side of the LCCs, directed through, between, and around the surfaces of the teeth and/or gingival area from the other side of the LCCs into the second manifold 1148 to provide controlled interdental, gumline, surface and/or gingival area cleaning or treatment.

Next, the flow in the manifolds is reversed. Cleaning fluid is pumped through second port 1144, and enters second manifold 1148 through second flow diverter 1145. Fluid enters back fluid lumens 1102e, 1102f, 1102g, 1104e, 1104f, and 1104g through back fluid lumen ports 1149. The cleaning fluid then enters LCCs 1154a and 1154b through inner back wall jet slots 1134. A vacuum is pulled on first port 1142 to pull the cleaning fluid through inner front wall jet slots 1132, into front fluid lumens 1102a, 1102b, 1102c, 1102d, 1104a, 1104b, 1104c and 1104d. The fluid enters first manifold 1146 through front fluid lumen ports 1147, then through first flow diverter 1143, and finally into first port 1142.

In the second portion of this embodiment, jets of cleaning fluid are directed onto the back surfaces of the teeth and/or gingival area, and directed through, between, and around surfaces of the teeth and/or gingival area. The alternating of pressure/vacuum through a number of cycles creates a turbulent, repeatable and reversible flow to provide reciprocation of fluid about the plurality of surfaces of the oral cavity to substantially simultaneously contact the surfaces of the oral cavity with fluid, thereby providing the desired beneficial effect.

In another embodiment it may be preferable to deliver the fluid through one or both manifolds simultaneously, flooding LLCs 1154a and 1154b, submerging the teeth for a period of time and then evacuating the LCCs after a set period of time through one or both manifolds. Here, cleaning or treating fluid is simultaneously pumped through first port 1142 into first manifold 1146 via first flow diverter 1143, and through second port 1144 into second manifold 1148 via second flow diverter 1145. Fluid then simultaneously enters front fluid lumens 1102a, 1102b, 1102c, 1102d, 1104a, 1104b, 1104c and 1104d through front fluid lumen ports 1147, and back fluid lumens 1102e, 1102f, 1102g, 1104e, 1104f, and 1104g through back fluid lumen ports 1149. The cleaning fluid then enters LCCs 1154a and 1154b through inner front wall jet slots 1132 and inner back wall jet slots 1134. To evacuate the LCCs, a vacuum is simultaneously pulled on first manifold 1146 through first port 1142, and second manifold 1148 through second port 1144. Cleaning or treatment fluid is pulled through inner front wall jet slots 1132 and inner back wall jet slots 1134, into first manifold 146 and second manifold 148.

It is also possible to deliver different fluid compositions to first manifold 1146 and second manifold 1148. The different fluid compositions would then combine in the LCC for improved cleaning efficacy or treatment effects. In the dual manifold design it may be preferable to supply each manifold from a separate fluid supply reservoir, such as in a dual action piston pump configuration, where one supply line connects to supply first manifold 1146 and the other piston supply line provides and removes fluid from second manifold 1148, e.g. when one manifold is being supplied with fluid the second manifold is removing fluid, and vice versa.

In other embodiments, valves can be placed at front fluid lumen ports 1147 of front fluid lumens 1102a, 1102b, 1102c, 1102d, 1104a, 1104b, 1104c and 1104d, or at back fluid lumen ports 1149 of back fluid lumens 1102e, 1102f, 1102g, 1104e, 1104f, and 1104g to provide improved function by allowing lumens to engage at different times (at different points in the cleaning/treatment cycle), at pulsed intervals. As an example, in one embodiment, not all lumens engage in the fluid pumping/vacuum function. Here, front fluid lumens 1102a and 1104a, and back fluid lumens 1102e and 1104e, which primarily engage the gums, only engage in the fluid vacuum function. This would help prevent fluid from leaking into the oral cavity. Valving also allows for variable flow, allowing a decreased resistance to the fluid vacuum function, or allowing increased pumping, and therefore fluid velocity, during fluid delivery.

In still other embodiments, individual inner front wall jet slots 1132 or inner back wall jet slots 1134 may have integrated one-way valves, such as duckbill valves or umbrella valves, to allow flow only in one direction out of those particular jets. This may be effective to increase vacuum relative to pressure/delivery in the LCC.

In some embodiments, the motion of the frictional elements discussed above, relative to the teeth, could be applied by a single or combination of mechanisms including, by not limited to, the fluid (via the jet slots or via turbulence of flow); movement of the membrane via the pulsing of the flexible application tray 1100; an external vibrational mechanism to vibrate the frictional elements; linear and or rotational movement of the application tray 1100 around the teeth through user jaw motion or external driving means.

In other embodiments, a conformable substance, such as gel, may be disposed near the back gum-sealing membrane 1158, allowing application tray 1100 to comfortably fit against the back of the mouth. Alternatively, the end of application tray 1100 may have a mechanism or attachment to extend or decrease the length of the mouthpiece to the proper length for each individual user, providing a semi-custom fit.

Manufacturing of the multi-lumen design is feasible utilizing existing available manufacturing and assembly processes such as extrusion, injection, vacuum, blow, or compression molding. Other feasible techniques include rapid prototyping techniques such as 3D printing and other additive techniques, as well as subtractive techniques.

The application tray may be custom manufactured for each individual user, or customizable by the individual user prior to use. For custom manufacture of the application tray, vacuum form molds can be created directly or indirectly from user teeth and gingival impressions, which create a model of the teeth which can then be modified to create required clearances and flow channels. These vacuum form molds can be created at low cost utilizing CAD and rapid prototyping processes.

One manufacturing method is to create individual component shells through vacuum forming. Low cost methods allow vacuuming forming of very thin wall structures. The component geometry is designed to provide the interlocking features and structural geometry to allow minimization of the size of the application tray. When assembled, the manufactured components form the necessary manifolds and flow structure (bidirectional and/or dedicated manifolds) to provide the required performance characteristics for treating/cleaning the teeth.

Customized mouthpieces are based on the user's teeth geometry, therefore creating a consistent distance between the mouthpiece and teeth may provide a more consistent cleaning/treating experience. The materials for each of the two-piece shell may be different, therefore allowing for softer material (on the inside shell) where it contacts teeth/gums and harder material on the outside shell to maintain rigidity and the overall shape.

For customizable application trays, tray pre-forms (similar to sport mouth guards or teeth grinding appliances) containing pre-manufactured manifolds, nozzles and channels are mass manufactured. The tray pre-forms can be created through a variety of known manufacturing techniques including, but not limited to, blow molding, vacuum forming, injection and/or compression molding. The material used in the pre-form would be a low temperature deformable plastic material. The pre-form would be used in conjunction with required spacers to be applied over the teeth to provide required clearance, cleaning and/or treatment performance. Once the clearance components are applied to the teeth, the pre-form would be heated via microwave or by placing in boiling water so as to be pliable. The pliable pre-form would be applied onto the user's teeth and gingival area to create the customized application tray.

The application tray can be integrated with stressing features to allow elastic conformance to maximize positioning, comfort and performance during application and in use. For example, spring-like elements such as shins, clips and elastic bands may provide fitting over and against gums.

Materials for the MP lumen could range from lower durometer flexible materials (25 shore A) to harder materials more rigid materials (90 shore A), preferably being between 30 and 70 shore A.

Materials could be silicone, thermoplastic elastomer (TPE), polypropylene (PP), polyethylene (PE), polyethylene terephthalate (PET), ethylene vinyl acetate (EVA), polyurethane (PU), or multi-component (combination of materials and hardness) to achieve desired design and performance attributes.

The jet openings or slots could be made through a secondary operation such as drilling or punching, or formed during molding. Alternatively, the jet openings or slots could be inserted into the application tray to provide increased wear and or different jet performance characteristics, and could be combined with frictional cleaning elements or other components to enhance the cleaning and/or treatment affect.

### Gingival Seal

The gingival seal forms the bottom portion of the cleaning treatment chamber (CTC) and contacts with the gingival tissue in such a way as to clean the gingival area, including the sub-gingival pocket. In one embodiment, it provides positioning of the mouthpiece relative to the oral cavity and teeth, and creates a relatively isolated environment with minimal/acceptable leakage during operation, while designed to minimize the gag factor and comfort for the user. In one embodiment, the gingival seal is created by the frictional engagement and compression of an elastomeric material with the gingival. This seal is enhanced during the evacuation of the fluid within and during the cleaning and treatment cycles. The seal also functions as a secondary mechanism for attaching and assembling the manifold and CTC membrane. The size and shape of the gingival or gum seal preferably utilizes three basic sizes (small, medium and large), but is designed to allow different levels of customization as required by the user for comfort and cleaning/treatment efficacy. These sizes are paired with the three basic sizes of the manifold and CTC membrane components.

Alternate embodiments for obtaining the gingival seal include the following and may be used in combination with each other or with the embodiment above:

### Embodiment #1

The mouthpiece is positioned within the oral cavity and onto the gingiva. The seal and position is fixed relative to the teeth and gingival when slight biting pressure is applied against the bite standoffs/locating blocks. The mouthpiece would be made out of a single or combination of materials of different hardness and resilience. In the preferred embodiment, the “H” shaped mouthpiece would have flexible walls (vertical edges of the “H”) which would have a soft resilient gasket like material (closed cell silicone, gel filled seal, etc.) at the ends of each of the “H” legs. The horizontal pad of the “H” would include biting blocks/standoffs for positioning the mouthpiece in the X, Y, and/or Z locations, relative to the teeth and gingival. Once the mouthpiece is positioned in the oral cavity, closing of the upper and lower jaw to engage the bite blocks would provide positive and rigid positioning of the mouthpiece relative to the oral cavity, while providing interference of the gasket like material with the gingival material to provide and effective seal and formation of the cleaning, treatment, and/or diagnostic cavity for the duration of the operation.

### Embodiment #2

Force applied to the mouthpiece to create inward movement of sidewalls, sealing a soft resilient edge against the gingival tissue. A mouthpiece similar to that described in embodiment #1 would also provide an active locking feature to improve the engagement of the seal. One potential execution of this would require that a hollow section be designed within the horizontal leg and between some or all of the standoffs between the upper and lower sections of the mouthpiece, when the device is not engaged. After the mouthpiece is placed in the oral cavity, the user bites down and compresses the hollow section, which then collapses so that all the bite blocks are in contact. This in turn causes the external walls (the vertical leg portions) to fold inwardly towards the gingival tissue. The resilient gasket attached to these walls engages and compresses against the gingival to create the seal and the cleaning, diagnostic, and/or treatment chamber surrounding the upper and lower teeth.

### Embodiment #3

A pneumatic bladder is inflated or pressurized when the mouthpiece is positioned in the oral cavity to create the seal and cavity with the gingival. A mouthpiece similar to that described in embodiment #1 could also provide an active seal through the inflation of a bladder, or bladders, within the mouthpiece. The air could also subsequently be utilized to clean and or dry the teeth/cavity and/or provide treatment (gas and or entrained particle in gas) for treatment, cleaning and/or diagnostics.

### Embodiment #4

A hydraulic bladder is inflated or pressurized when the mouthpiece is positioned in the oral cavity to create the seal and cavity with the gingival. A mouthpiece similar to that described in embodiment #1 could also provide an active seal through the pressurization of a bladder(s) within the mouthpiece. The fluid composition could also subsequently be utilized to clean and/or treat the teeth and or gingival tissue with or without gas or entrained particles for cleaning, treatment, or diagnostics.

### Embodiment #5

After the mouthpiece is positioned in the oral cavity, the seal is created through a change in compliance of the material engaging the gingival with or without expansion of the material to seal around the gingival due to fluid absorption (utilize a hydrogel, etc.).

### Embodiment #6

After the mouthpiece is positioned in the oral cavity, Nitanol wire or other shape memory materials embedded into the mouthpiece cause the side walls to engage the gingival due to the change of body temperature in the oral cavity, creating a positive seal with the gingival tissue.

### Embodiment #10

A foam-like material is extruded into the mouthpiece area initially or alternatively during each use to create the mouthpiece seal and subsequent cleaning, treatment, and diagnostic cavity.

### Embodiment #11

A disposable or dissolvable insert is provided to provide the seal to the gingival tissue for multiple or each use of the mouthpiece.

### Embodiment #12

An adhesive is contained on the gum seal contact surface, which can be saliva or water activated. Adhesive would provide potential seal improvement and could be single use or multiple use application, depending on the formulation. Sealing system can be used with any combination of other sealing systems discussed.

### Embodiment #13

The gingival seal is created through a combination of material on contact area and geometry at the interface that creates a suction-like effect in the seal contact area (suction cup) through creation of a vacuum in this area during the engagement.

### Embodiment #14

The gingival seal area can be made and customized to a user's mouth by utilizing a deformable material that can be placed and positioned against the gingival, which then takes on a permanent set for the user. This may be created through boiling and placing in the mouth and pressing against the gingiva by closing the jaw and or like method, then removing from the oral cavity (similar to a mouth guard). As the sealing material cools, it takes on a permanent set.\

### Embodiment #15

The gingival seal area can be created by taking a generic or semi generic bladder and placing into the oral cavity in close proximity to the desired gingival seal contact area. This bladder can then be filled and directionally supported to engage and conform against the gingival. The filling material would be a fast curing material, which would take set to provide the customized sealing form, which would then be reusable by this specific user. The bladder could be a TPE and/or thin silicone based material, and the filling material could be an RTV, epoxy, polyurethane or similar material to provide a rigid, semi rigid or flexible permanent set form when cured or set.

### Components

The entire system will be modular in nature so individual components can be easily replaced by the user. Reasons for replacement include but are not limited to wear, malfunction, and biohazard. Some components may also be disposable and replaceable by nature (refill cartridges, etc), thus modular and easily replaced by the user.

### Pump System

In the preferred embodiment, the fluid may be delivered from a reservoir in the mouthpiece handle or base station via powered pump. The pump may be capable of responding to input from a logic system (artificial intelligence, or AI) to vary pressure, cycle time (for each stage and total process), reciprocating motion requirement and/or timing, direction of flow, fluid velocity/pressure, purge specifications, and similar. The pump may be a piston pump, valveless rotary piston pump, diaphragm pump, peristaltic pump, gear pump, rotary pump, double-acting piston pump, vane pump, or similar. A charged pneumatic cylinder or air compressor may also drive the system as an alternative embodiment. The cycle time for the total process, cycle time for each individual stage, and flow velocity for each stage of the cycle may be variable and potentially customized to each individual user/day of the week/oral health conditions. It is also possible to change the volume of fluid delivered per stroke or over a time period in different offerings of the system, depending on the needs of the specific user and specific treatment requirements. The pump system may be in the hand piece or in the base station. The volume of fluid per stroke of the piston pump may be relative large to give the effect of pulses of fluid in the mouthpiece. An alternatively embodiment has a pump that delivers constant flow with low or no pulsations. In the preferred embodiment, the forward stroke will deliver fluid to the mouthpiece through specified nozzles and the back stroke will create a vacuum to suck fluid through specific nozzles in the mouthpiece back to the pump. The direction of the fluid to and from the mouthpiece can be reversed by changing the direction of the motor in a rotary valveless pump, directional valve, or other means. The fluid drive system will not start until the mouthpiece is properly inserted and sealed against the gums. The system will automatically stop dispensing and may remove residual fluid from the mouth once the mouthpiece is removed (seal against gums is broken) from the mouth. This will allow the user to increase the concentrations of active ingredients in the cleaning/treatment formulation. The system will not start until the mouthpiece seals against the gums. In one embodiment the pump system is entirely contained in the hand piece, and in another the pump system is housed in the base station.

### Valving/Fluid Control & Fluid Input/Output

It may be desirable to change the direction of the flow to the mouthpiece, if the mouthpiece embodiment is used wherein the mouthpiece has one inlet and one outlet. The direction of fluid flow through the teeth would be reversed by changing the direction of flow of the inlet and outlet to the mouthpiece, therefore increasing the efficacy and sensory affects of the cleaning process. The mouthpiece may have nozzles on opposite sides of the teeth wherein one side of the jets are pressured and the opposite side draws a negative pressure differential. This forces the fluid “through/between” the teeth. The flow is then reversed on each set of nozzles to move the fluid the opposite direction through the teeth. The fluid may then be reciprocated back and forth. The direction of flow may be reversed and/or reciprocated by reversing the direction of a specialized pump, such as a rotary valveless pump. Another embodiment includes but is not limited to reversible check valves, wherein the orientation of the check valves to the pump is reversed, thereby reversing the direction of the flow throughout the system. Another embodiment includes controlling (2) 3-way valves with the logic (AI) system to reverse the direction of flow when activated. A further embodiment has a logic (AI) system to control (1) 4-way valve with one input from the pump, a return to the pump, and two outlets to the mouthpiece that can reverse flow direction as desired. Another embodiment involves configuring tubing so as to shut off of the flow with pinch valves to specific tubes in order to reverse the flow of the system. Another embodiment includes development of a fluid control switching box that connects two tubes on one side of the box to two tubes on the opposite side of the box. In one orientation the fluid flow moves directly across the box from one collinear tube to the next, while in the other position the fluid flow moves in an “X” direction whereby fluid flow direction is “crossed” in the switching box. In another embodiment, flow is reciprocated by using a double-acting piston pump, wherein the flow is constantly reciprocated back & forth between the two piston pump heads.

In one embodiment the fluid control system is entirely contained in the hand piece, and in another embodiment, the fluid control system is housed in the base station. The tubing used in the system must withstand both pressure and vacuum states.

One or more fluid types from individual reservoirs can be delivered through the mouthpiece individually or combined. Any combination and concentration variation can be used. The reservoirs may reside in the hand piece or in the base station.

The system may include manual and/or automatic air purging, and/or an accumulator to provide system compressibility.

### Interface (Electrical & Fluid)

The hand piece may have an electrical and/or communication system that interfaces with the base station. This includes but is not limited to charging of the rechargeable battery, transferring diagnostic information between the units, transferring custom profile information between the units, and transferring program-related information between the units. Information can be transferred wirelessly (RFID, 802.11, infrared, etc.) or through a hard connection. The electrical system will include logic so as to control the function, start, and stop of the system based on preset criteria. The criteria may include starting only after a seal has been created between the mouthpiece and the gums, ensuring a properly charged fluid system, ensuring a minimum battery charge level, ensuring the fluid level is within a specified range, etc. There may be a logic system that may communicate with various components of the device including, but not limited to, initiating algorithms to control the sequencing of the valves, motion of the piston and therefore motion of the fluid, receive inputs from the consumer, receive inputs from the temperature sensor, receive diagnostic input, detect engagement of the mouthpiece seal against the gums, etc. The logic system must be capable of processing and responding to an input and outputting appropriate data. The system may include redundant circuitry wherein providing a fail-safe design.

The system may include a means to provide feedback to the user such as lights, display, touch screen, recorded messages, vibration, sounds, smell, and similar. It may also have a means to operate the system and select processes/settings, such as switches, touch screens, buttons, voice commands, and similar.

The system may include a means for tracking statistics such as time between uses, length of use/cycle, total uses, regimen details (amount and time of each fluid/treatment), time to replace specific system components, and similar. The system may provide feedback to the user to indicate time replace or refill wear, disposable, or replaceable components.

There will be a method of fluid supply, which may be a fluid reservoir, hose supply system, or similar. The fluid supply may be located in the base station and transferred to a reservoir in the hand piece when the hand piece is docked in the base station. The fluid may then be delivered through the mouthpiece during the cleaning process, and purged out of the system delivery and/or after the cleaning process. In another embodiment, the hand piece is connected to the base station with a fluid connection means, and fluid is delivered from a reservoir in the base station, through the hand piece, directly to the mouthpiece.

There may be consumable cartridges that may contain treatment solutions, cleaning solutions, diagnostic solutions, or similar. The cartridges may be modular in design so as to be easily replaceable by the user.

The system may include a means of detecting the level of plaque on the teeth. One such method of detection is by coating the teeth with a fluorescein solution, which has been proven to stick to plaque, and monitoring the light waves emitted from the fluorescein-coated plaque vs. uncoated teeth regions. The light wave is different for each region, therefore it is discernable which areas and how much plaque exists on the teeth. Other similar methods of plaque detection may also be used, such as vision systems.

### Cleaning/Purging/Charging

The fluid system may be charged with disposable cartridges, refilling of a chamber, accessing a main reservoir in the base station with tubing, or other means of fluid transfer (gravimetric, hand pump, siphon pump, use of main pump drive or secondary system to fill/charge reservoirs, and similar). The fluid reservoirs may be filled with a combination of different fluids to create a unique combination of different fluid concentrations. In another embodiment, ingredients may initially be in a form other than fluid (gel, powder, tablet, and similar) and may be combined with fluid for added treatment and/or cleaning benefits.

The hand piece will have a purge setting that is simply and easily activated by the user during and/or after the cleaning process. This can be accomplished with a method such as a single button pushed by the user that will purge the hand piece of fluid and waste. In another embodiment, the excess fluid and waste is transferred from the hand piece to a waste reservoir or the sink drain, outside of or docked in the base station. There may be a filtration system to protect the components from contaminants. In a further embodiment, the hand piece houses a disposable waste cartridge. In an alternate embodiment, the mouthpiece is cleaned in the base station between uses. The cleaning method includes, but is not limited to, UV cleaning, alcohol bath, alternate cleaning fluid bath, or other similar method. The fluid cleaning bath may or may not circulate in and/or around the mouthpiece.

### Drive System

The fluid system may be driven by a linear motor, or series of linear motors. As used herein, “linear motor” is a motor in which the motion between the rotor and stator are linear due to electromagnetism, which provides thrust in a straight line by direct induction instead of through gears. This would possibly reduce the size of the fluid system and gain additional control of fluid delivery through fluid vacuum. The motor(s) may directly drive the pistons up and down in a translational fashion.

In order to optimize the design and minimize the size of the device, the components of the linear drive may be integrated into the pump system. The piston itself may incorporate the magnet and the coil may be imbedded in or around the outer piston chamber walls. Alternatively the piston and/or fixed attachment means to piston can be moving portion and the magnet can be stationary (i.e. surrounding or within the piston walls). In addition, both the vacuum and delivery pistons may have imbedded magnets that act against one another to create or assist with the piston movement.

The motor will also drive the movement of the reciprocating flow controller. A linear motor may drive the FDM in a ratcheting fashion or geared fashion, such as motion transference like the geneva mechanism.

In some embodiments, the pumping and vacuum sections may be oriented in-line with one another. Alternatively, they may be oriented parallel to each other. Each orientation has different advantages in regard to compactness. The pumping and vacuum sections can be connected together, or alternatively operate independently, being synchronized in frequency and/or some factor of frequency (i.e. vacuum section could have the volumetric displacement of the delivery section, but move at a different speed) or could run asynchronously. If the delivery and vacuum sections are oriented in-line with one another, they may be connected to each other via a rod. This may allow the delivery and vacuum pistons to be driven simultaneously, ensuring synchronization between the pumping and vacuum strokes.

The delivery piston may be driven by the same rod that drives the vacuum piston, but may have also some damping means and or delay one to the other, such as slot where it attaches to the piston. This may allow for extra play in the drive piston, causing the vacuum stroke to start slightly before the delivery stroke and continue slightly after the delivery stroke. This may give the vacuum stroke additional opportunity to remove fluid from the appliance since it is still creating a vacuum while the delivery piston is dwelling, as well as minimizing leakage due to gravity and appliance position into the oral cavity.

The sequence and timing of the vacuum and delivery systems during device operation may be controlled to improve user comfort, convenience, and cleaning efficacy of the device. For example, one sequence of the timing between these two systems could be as follows. The device is initially at rest with the vacuum and delivery systems both disengaged. The device is positioned properly by the user for oral care cleaning and/or treatment. The user initiates the cleaning/treatment process by, for example, pushing a start button on the device. Once the process is started, a program is initiated that actuates the vacuum system. The delivery system remains disengaged for a period of time.

During this time period, where the delivery system is not engaged (no fluid is being applied to the oral cavity) a negative pressure in the fluid contacting chamber (LCC) relative to the oral cavity outside of the LCC develops, allowing a flexible application tray, or mouthpiece, to dynamically change shape to improve conformance to the user's teeth and gums, improving the fit, function, and user comfort. This negative pressure may also help draw the fluid into the vacuum ports once fluid delivery begins. For custom, rigid, or semi-rigid mouthpieces which closely conform to the gingiva, the vacuum can be used to create an effective positive seal of the mouthpiece to the gingiva.

Next, the fluid delivery system may be automatically actuated after a preset time period. The negative pressure in conjunction with the formed mouthpiece would minimize and/or allow improved control of any residual fluid leakage into the oral cavity, minimizing the impact of fluid leakage from the LCC into the oral cavity. At this time, both the vacuum and delivery systems could be running in parallel. The vacuum system may also be driven at a variable rate and increase when needed to provide adequate/target vacuum. After a preprogrammed set time period, the fluid delivery system may automatically be disengaged, while the vacuum system remains engaged. This would allow the system to remove fluid that may have leaked into the oral cavity. The LCC and mouthpiece may also be evacuated of residual fluid.

The vacuum system may then disengage after a set period of time, and the cleaning/treatment cycle may be completed. The user may then remove the mouthpiece from their oral cavity. Dripping of fluid from the MP and/or unwanted leakage into the oral cavity could be controlled, resulting in an improved experience for the user.

In some cases, it may be desirable to supply a controlled amount of fluid into the oral cavity. To achieve this, the controlled sequence timing between the delivery and vacuum systems, may be as follows. Once the above cleaning and/or treatment process is completed, the delivery system would automatically initiate for a set period of time to deliver an amount of fluid with the vacuum system remaining disengaged. Due to positive flow pressure, the fluid would leak/flow out of the LCC and into the oral cavity. Once the required amount of fluid was dispensed into the oral cavity, the delivery system could be disengaged automatically or manually. The vacuum system could then be reengaged automatically to clear out the LCC and manifolds, while still leaving a quantity of fluid in the oral cavity for subsequent rinsing and/or treatment of the oral cavity.

If desired, a sensor could be located in the mouthpiece that will send signal to confirm correct positioning of the mouthpiece in the oral cavity. Alternatively, the sensor could be located in a position on the handle, such as, but not limited to, directly under the mouthpiece. In this case, the sensor could be activated by proximity of the chin and/or lips, which correlate to the correct placement of the mouthpiece in the oral cavity. This sensor may also alert the program/hardware if during the use cycle, the mouthpiece is removed from the mouth or into an incorrect position. Such a change may result in the delivery being immediately disengaged while maintaining or initiating engagement of the vacuum system to remove excess fluid from the oral cavity and the mouthpiece.

The vacuum and delivery system sequence timing system may work for both single driven (shared motor) and multiple driven (separate motors) systems. If both the vacuum and delivery systems are powered by the same motor, relative system engagement timing may be accomplished in a number of different ways. One way would be to provide a clutch between the pump drive system and the motor on either or both the vacuum and delivery pumping systems. Common clutch types that could be used and are known in the art are centrifugal, electronic, or electro-magnetic. The clutch would be disengaged when operation of the delivery, or separately the vacuum system, as not required, and engaged when either or both systems were needed.

Another method could be to reroute or bypass the output of the delivery and/or vacuum system from the mouthpiece input or output. This may be done through a valved system that is mechanically actuated, through a driven cam or gearing system, or through a pressure relief valve (valve actuated only when certain relative pressures are reached) or a combination of both. This may also be electrically actuated using a solenoid or motor driven valve system.

Yet another method may be to create a mechanical delay in the pumping mechanism. This could be accomplished by delaying the delivery stroke in a piston pump, relative to the vacuum piston engagement. One example of this would be to allow the delivery piston to float relative to the piston crank for a set distance before the frictional component of the piston engagement with the cylinder was overcome, resulting in movement of the delivery piston and actuating of the fluid delivery. In this example, the vacuum piston could be rigidly connected to the crank arm, and would initiate immediately with the crank arm movement. The crank arm movement of both the vacuum and delivery would be rigidly connected to the motor and would initiate motion at this same time, as the motor was turned on. However, due to the built in piston delay, the delivery piston could lag the vacuum, providing benefit as described in the timing example.

If the vacuum and delivery pumping systems have independent power sources, the vacuum and delivery systems may be controlled independently to create the synchronization timing benefits as previously described. In one design, the vacuum unit motor may be actuated via electronic control, once the start button has been actuated by the user. The motor would run for a set amount of time, developing a negative pressure in the mouthpiece. The delivery system motor may be deactivated at this time. After a set time, the delivery motor may also be activated, driving the delivery pump system. The delivery and vacuum motors may then run simultaneously for a set period of time. After a set time, the delivery system motor may be deactivated, halting its pumping action. The vacuum system motor may still be engaged for a set period of time to evacuate the oral cavity and the mouthpiece. After a set time period has elapsed, the vacuum system motor and associated pumping system may also be deactivated completing the process. The mouthpiece may be removed from the user's mouth, resulting in minimal dripping or leakage.

The above example may also be accomplished with any number and combination of independently driven pumping systems, including but not limited to rotary, diaphragm, & peristaltic pumps.

The vacuum piston and delivery piston may have means to dump fluid into reservoir as a safety, in case either experiences any sort of partial or full blockage, which could result in premature failure of device components (motors, valves, seals, etc). This allows for safe and controlled operation and prevents over pressurization when the main flow ports are have been compromised and repeatable device performance for efficacy. By dumping into the local reservoir instead of to atmosphere, leakage potential outside of the device is minimized.

### Temperature Control

In one embodiment, the fluid temperature may be controlled within a specified range. If the fluid is too cold, it may cause discomfort and sensitivity in the user's mouth. If the fluid temperature is too high, it may cause discomfort, sensitivity, and damage to the user's mouth. The system may be confirmed not to run if the fluid temperature above the specified limit. A heating element may increase the temperature if it is below the minimum specified limit. The system may be confirmed not to run unless the fluid temperature is within the specified range. The temperature feedback may be provided, but is not limited to thermistors, thermocouples, IR or other temperature monitoring means. This information may be fed back to the logic (AI) system.

The drive system may have means to heat the fluid to a specific temperature range. Fluid may be heated in one or more locations of the system. Methods of heating the fluid include, but are not limited to, an inductive element, a radiant element, a ceramic element, a tubular sealed heating element (e.g. a fine coil of Nickel chrome wire in an insulating binder (MgO, alumina powder), sealed inside a tube made of stainless steel or brass), a silicone heater, a mica heater, or an infrared heater.

### Fluid Separation

Air/fluid separation is needed to optimize the efficiency of the device. Air is drawn with the dispensed fluid into the device via the vacuum system, and must be separated from the fluid prior to being resent to the mouthpiece through the delivery system. If too much air is present in the system, there is potential for loss of priming in the pumping system. Also, a decrease in fluid velocity and pumping efficiency may occur due to the compressibility of air relative to fluid in the system. This issue can become more critical when there is a desire to minimize the quantity of fluid required for a single cleaning session. As this fluid quantity is reduced, there is less time to allow separating the air from the fluid. In an effort to address and control the quantity of the air to fluid entrainment in operation, some of the following methods and techniques may be utilized separately or together, as well as other methods known in the art but not mentioned here, to achieve the desired result of controlling the fluid air content, while minimizing the device size and fluid quantity used.

In some cases, the cleaning and or treatment fluid contains an anti-foaming agent or agents. These agents prevent foam from forming in the fluid by preventing air entrainment from occurring. A defoaming agent or agents may also be used to break down foaming (bubbles) if it does form. One agent that is commonly used for this purpose is poly(dimethylsiloxane), silicon dioxide, also known as Simethicone. Simethicone decreases the surface tension of gas bubbles, causing them to combine into larger bubbles, which can be removed/popped more easily from the fluid. The impact to Simethicone in Listerine Cool Mint mouthwash was tested in 200 ml of Listerine Cool Mint mouthwash. Mouthwash was placed in two 300 ml jars. In one jar, 250 mg of Simethicone was added to the mouthwash. In the second jar nothing was added (control). Both jars were capped and tightened to be air and leak tight, capturing approximately 100 ml of air to the 200 ml of mouthwash. Both jars were shaken rigorously for 10 seconds. The results showed that the shaking of the control (mouth wash only) entrained a significant amount of air creating a foam with a volume of approximately 80 ml, when measured seconds after the shaking was stopped. The Simethicone treated mouthwash by comparison exhibited virtually no foam formation with less than 2 ml of foam measured.

Silicone defoaming additives are also commonly utilized in formulations to break down bubbles. Lower viscosity fluids typically have improved resistance to foaming. Note that defoaming and antifoaming agents are frequently used interchangeably. Some currently know defoamers can be oil based, silicone based, ethylene oxide based, propylene oxide based, an defomers that contain polyethylene glycol and polypropylene glycol copolymes, and/or alkyl polyacrylates.

Mechanical bubble/foam popping and air releasing geometries in the device may also be used to break and release bubbles within the flow. Mechanical geometries include, but are not limited to, screens and flow barriers.

Centrifugal separators, also called fluid separators, and mechanical separators could be used to break down foams in the device. These devices use centrifugal motion and gravity to force fluid out of the air. The spinning causes the fluid to join together on the centrifugal separators walls when the condensate gains enough mass it falls to the bottom of the separators bowl or reservoir, where it pools in until it is taken back up by the delivery system. The system is also sometimes described a cyclone separator or hydro-cyclone.

Also, air permeable membranes that allow air to freely pass through, but prevent fluid flow, may be used to break down foams in the device.

In one embodiment, the hand piece will be a self-contained, portable unit with a rechargeable battery, have a motor-driven piston pump for fluid delivery, have a mechanism to control the fluid flow, keep the temperature within a specified range, be modular in design, and have ergonomics well-suited to the user's hand. When the hand piece is in the base station, it will recharge the battery, refill the fluid reservoirs in the hand piece from those in the base station, and exchange samples and/or diagnostic information with the base station. It may also go through a cleaning process.

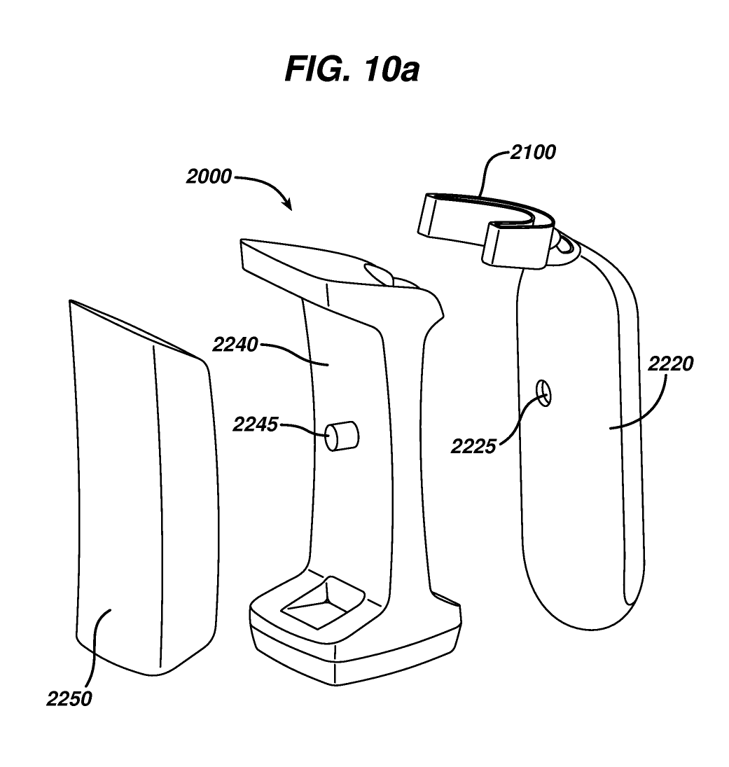

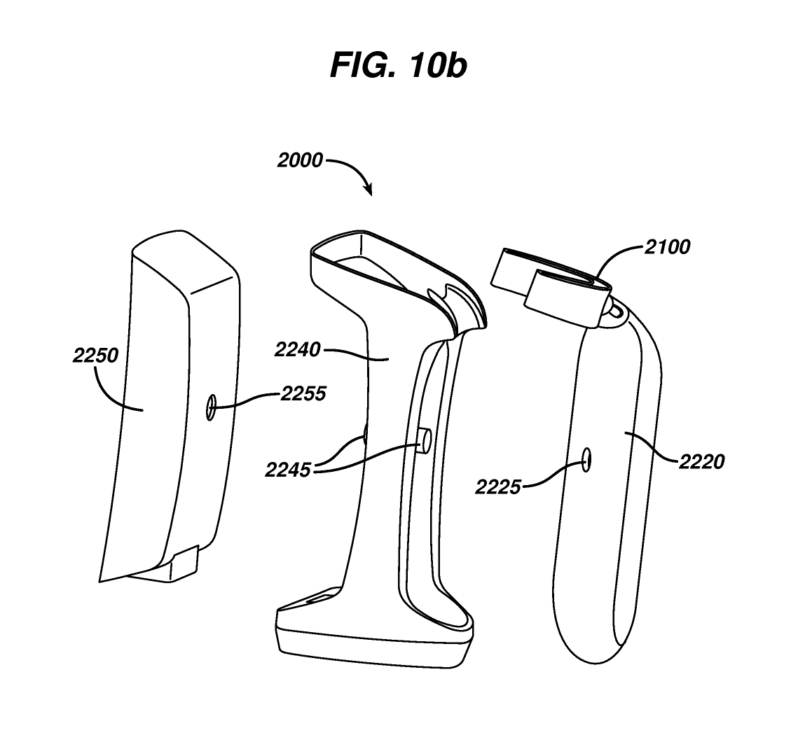

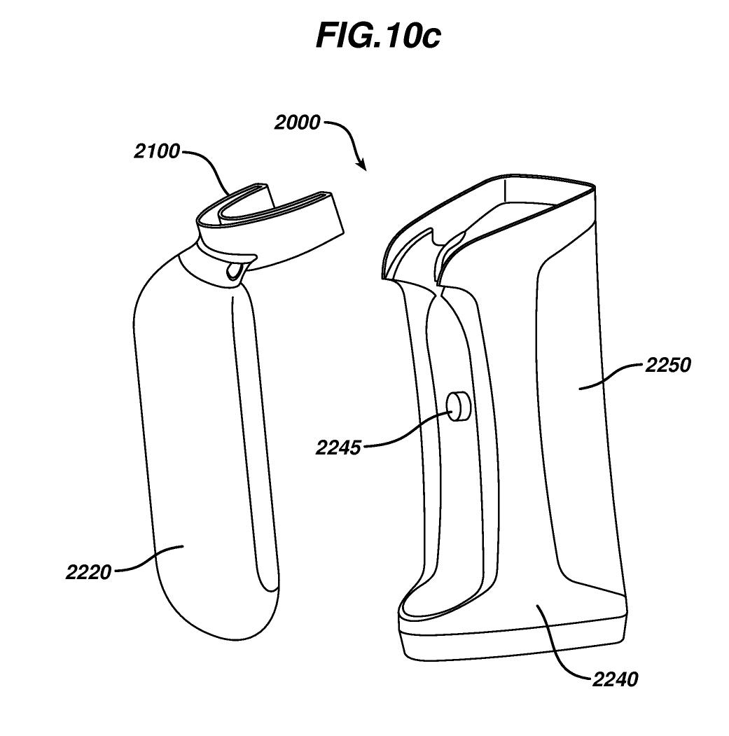

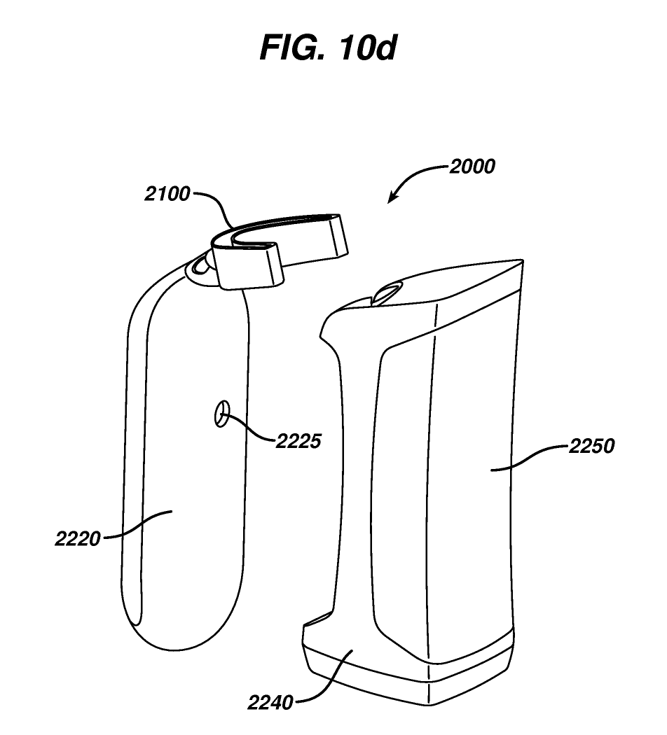

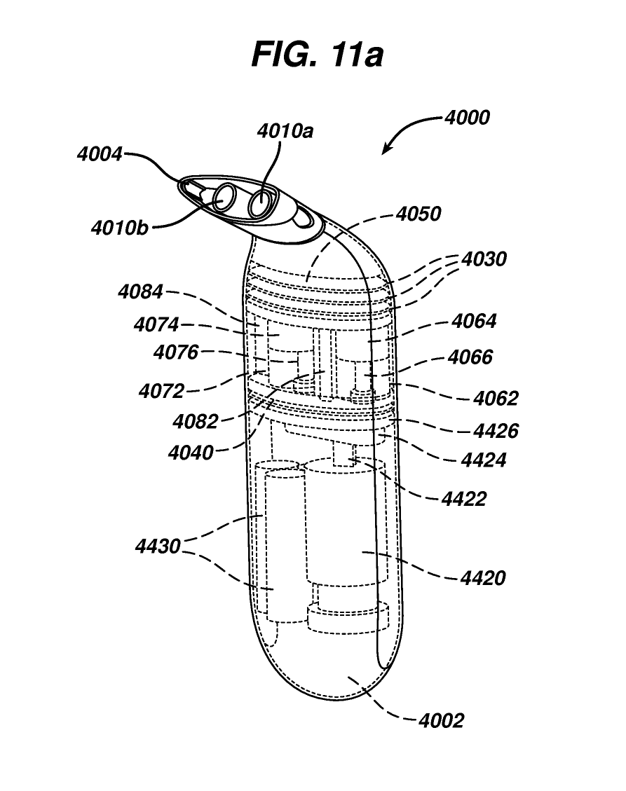

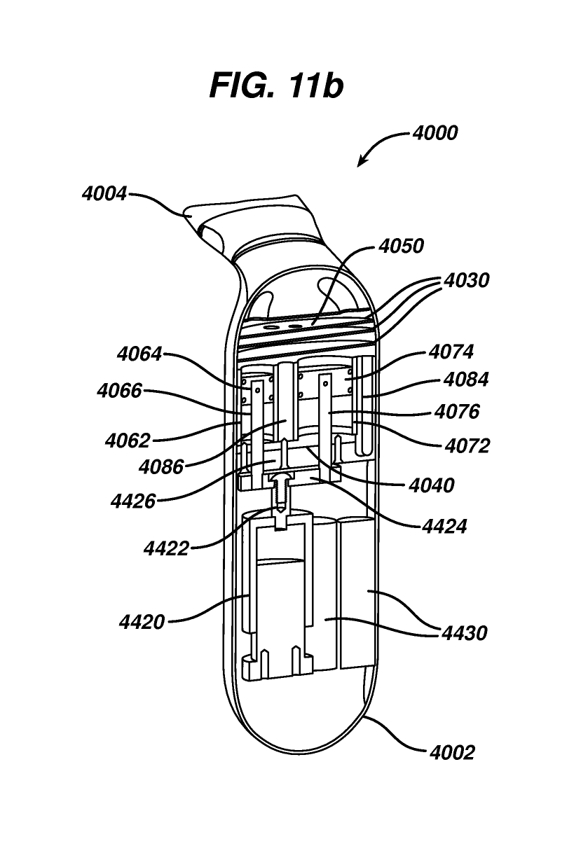

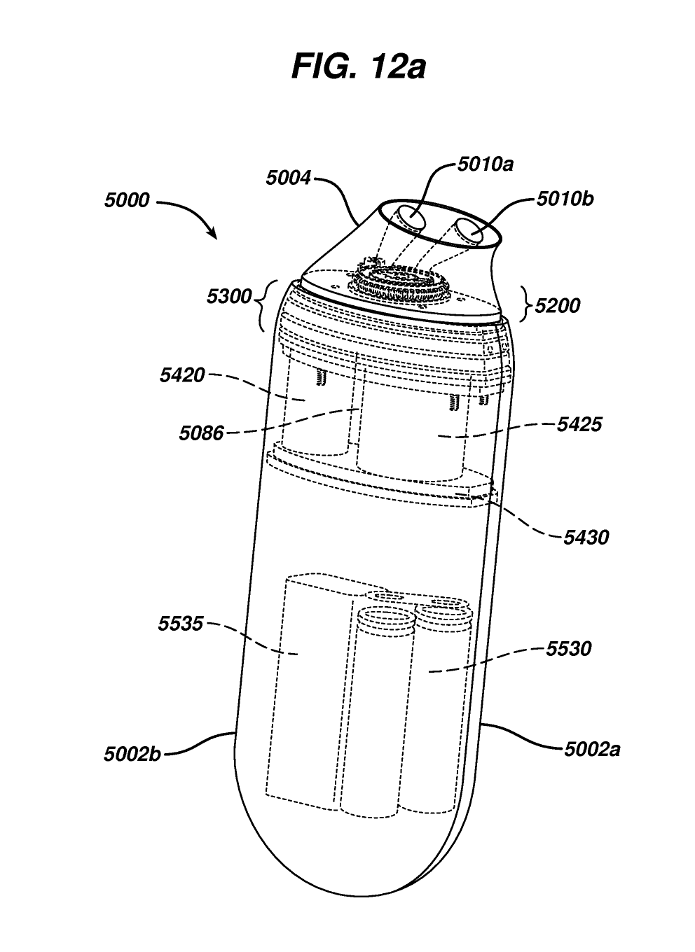

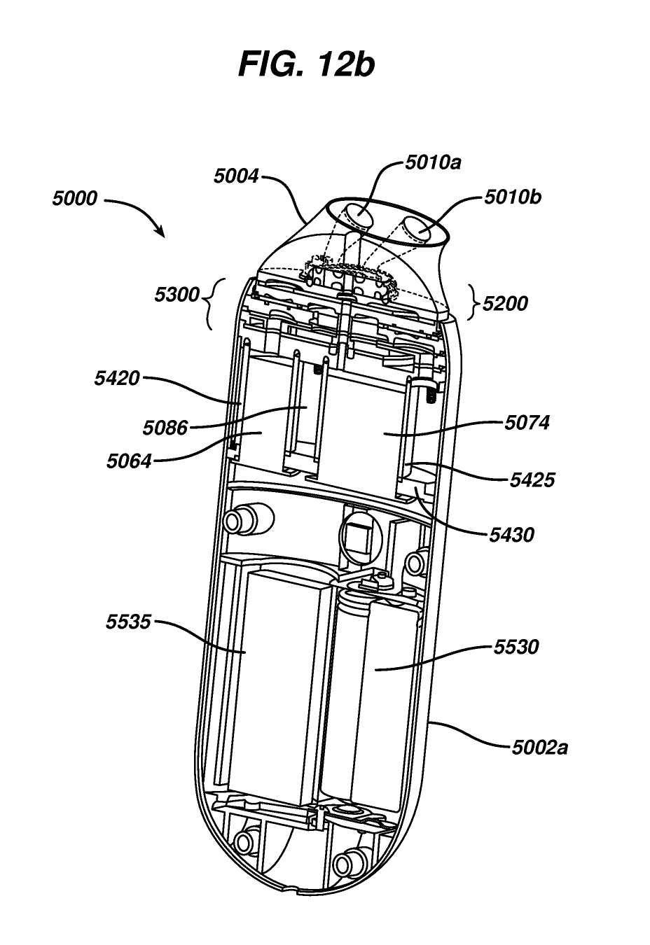

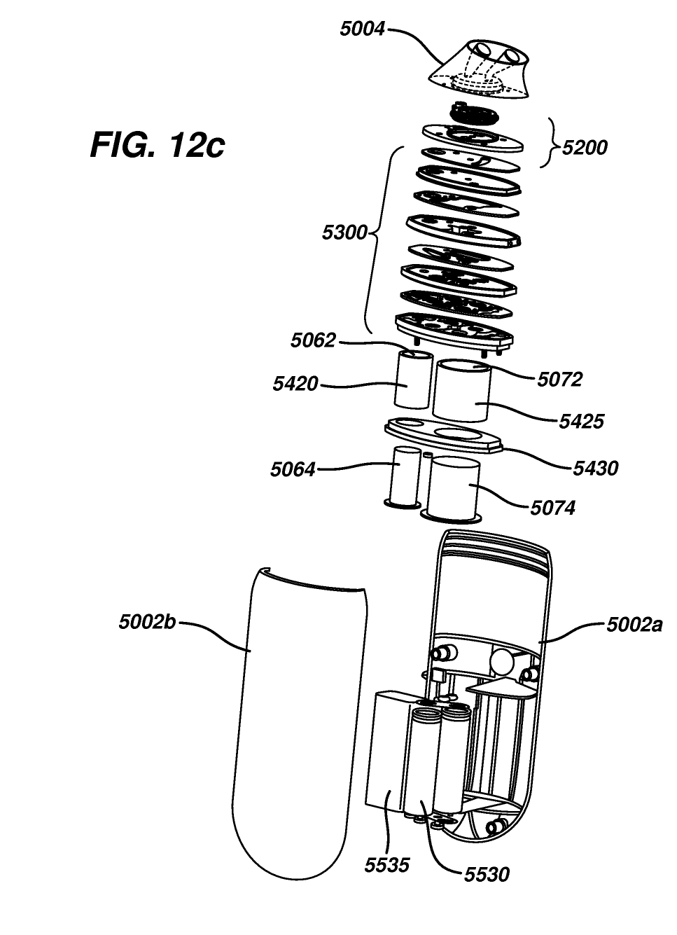

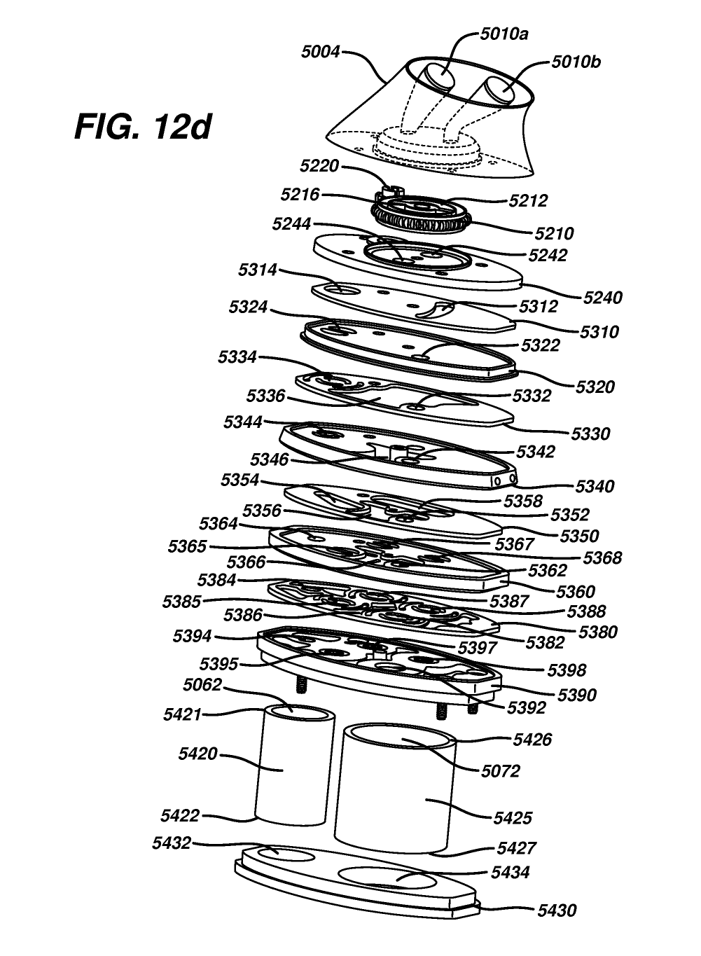

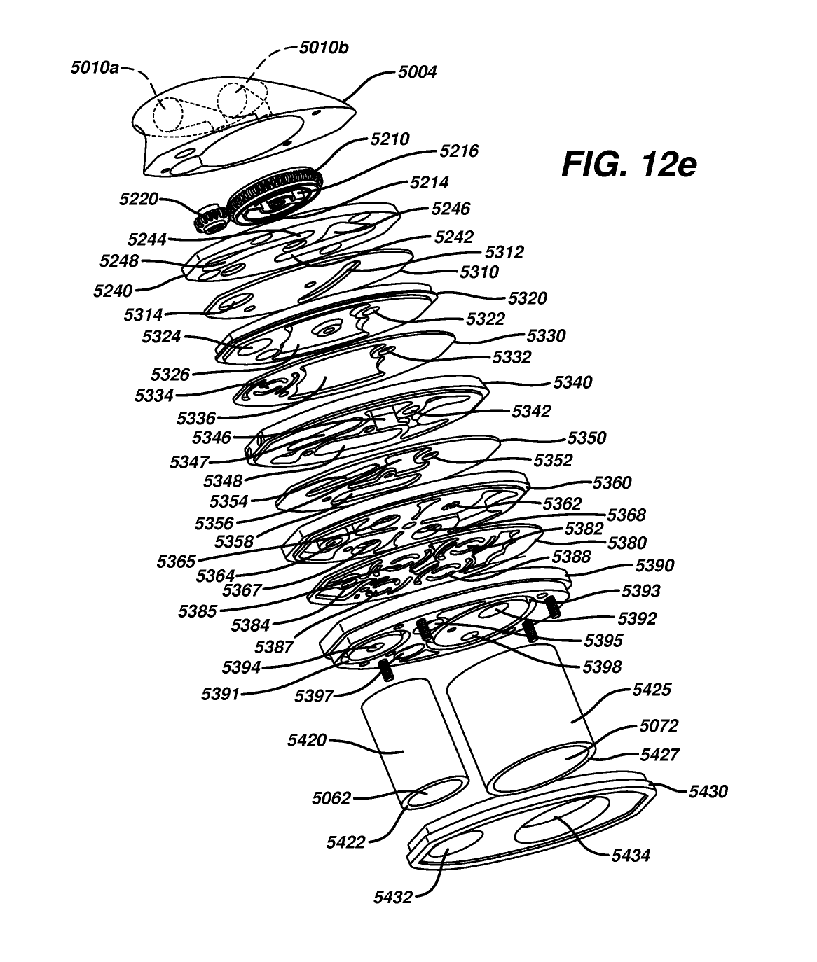

FIGS. 10a-10d show a representation example of an embodiment of a dental cleaning system 2000 of the present invention. The figures show dental cleaning system 2000, showing hand piece 2220, base station 2240, and base station fluid reservoir 2250. Base station fluid reservoir 2250 is used to refill the fluid reservoirs in hand piece 2220. Application tray 2100 is shown attached to hand piece 2220.

In this embodiment, base station fluid port 2245 is the conduit through which cleaning or treatment fluid passes from base station fluid reservoir 2250 to the fluid reservoirs in hand piece 2220. Fluid leaves base station fluid reservoir 2250 through base station fluid reservoir port 2255, and enters the fluid reservoirs in hand piece 2220 through hand piece port 2225.

When in base station 2240, the internal battery of hand piece 2220 will recharge, and the fluid reservoirs in hand piece 2220 will refill from those in base station 2240. Any diagnostic information in hand piece 2220 will be exchanged with base station 2240. Hand piece 2220 may also go through a cleaning process.

In other embodiments, a piston pump with check-valves will be used for fluid delivery.

In yet other embodiments, a rotary piston pump will be used for fluid delivery. This pump is known by those in the art, and the piston rotates as it reciprocates, therefore not needing any valves to operate. Reversing the rotation direction of the drive motor will reverse the fluid flow direction.

In still other embodiments diaphragm pumps, gear pumps, or double-action piston pumps will be used for fluid delivery. In the case of double-action piston pumps, when the fluid system is charged, this pump type has the benefit of reciprocating the direction of the fluid flow to the mouthpiece. Charged pneumatic cylinders, hand pump, or rotary pumps may be used to drive the system.

Another embodiment of a hand piece according to the present invention is shown in FIGS. 11a and 11b. In this embodiment, hand piece 4000 is designed in a modular fashion, with a pumping section, vacuum section, reciprocating section, fluid storage section, and a single drive pump to drive both pumping and vacuum sections. This embodiment allows for increased control, comfort, simplification and miniaturization of a hand-held, fluidic oral care cleaning device. The invention also provides improved ergonomics, compactness, aesthetics, and portability of a fluidic hand held system. The fluid flow switching system is also designed to minimize space and power requirements, while providing maximum functionality through conversion of the linear motion of a linear motor to the rotary motion required to drive a rotary flow switching disk.

Hand piece 4000 includes an outer shell 4002 with an upper and lower portion separated by a divider plate 4426. The upper portion of hand piece 4000 includes mouthpiece receptacle 4004, inlet/outlet pipes 4010a and 4010b, top control valve assembly 4030, bottom control valve assembly 4040, reciprocating flow controller 4050, delivery cylinder 4062, vacuum cylinder 4072, vacuum flow tubes 4082 and 4084, and delivery flow tube 4086. Delivery cylinder 4062 includes delivery piston 4064 connected to delivery rod 4066. Vacuum cylinder 4072 includes vacuum piston 4074 connected to vacuum rod 4076.

The lower portion of hand piece 4000 includes linear motor 4420 and power source 4430. Linear motor 4420 is connected to drive rod 4422, which, in turn, is connected to drive plate 4424. As shown in FIG. 11b, drive plate 4424 is connected to both delivery rod 4066 and vacuum rod 4076, so, single linear motor 4420 drives both pumping and vacuum sections. Delivery rod 4066 and vacuum rod 4076 both pass through divider plate 4426.

In this embodiment, delivery cylinder 4062 and vacuum cylinder 4072 are shown configured side by side, but these cylinders can also be configured above and below. In this embodiment, the delivery system volumetric flow rate is approximately one third that of the vacuum shown for a single stroke of drive rod 4422.

Drive rod 4422 of linear motor 4420 can be either connected to a moving coil/stationary magnet, or moving magnet/stationary coil as shown in FIGS. 11a and 11b. The linear motor can be single, double or multiple poles and may be driven by electronic control.

Power source 4430 is shown in the form of batteries in FIGS. 11a and 11b. The batteries could be single use or rechargeable. It is understood that power source 4430 could also be in the form of a transformer that converts alternating current (AC) to direct current (DC). In this case, hand piece 4000 will include an electric power cord.

The local reservoir is defined as the volume located around the outside of the delivery cylinder 4062, vacuum cylinder 4072, and flow tubes (4082, 4084, and 4086), and inside outer shell 4002 between top control valve assembly 4030 and bottom control valve assembly 4040. This design maximizes the use of space inside outer shell 4002, and minimizes the size of hand piece 4000.

In operation, the local reservoir feeds fluid to delivery cylinder 4062 through delivery flow tube 4086, and a one-way valve in top control valve assembly 4030. This allows one way flow from the local reservoir to fill the delivery cylinder 4062 during the back stroke of drive rod 4422. The fluid is forced out of delivery cylinder 4062 during the upstroke of drive rod 4422, through a second one-way valve located in top control valve assembly 4030. The fluid flows through reciprocating flow controller 4050, and out either of the bi-directional inlet/outlet pipes 4010a and 4010b, which are located in mouthpiece receptacle 4004 of hand piece 4000, and into the mouthpiece (not shown).

Though shown as single acting in FIGS. 11a and 11b, delivery cylinder 4062 can be single or double acting. If single acting, the volume of delivery cylinder 4062 above delivery piston 4064 delivers fluid to the mouthpiece. A double acting delivery cylinder 4062 would use the volume of delivery cylinder 4062 above and below delivery piston 4064 to deliver fluid to the mouthpiece. This would require some changes to either top control valve assembly 4030 or bottom control valve assembly 4040.

FIGS. 11a and 11b show vacuum cylinder 4072 as double acting. A double acting vacuum cylinder 4072 uses the volume of vacuum cylinder 4072 above and below vacuum piston 4074 to pull fluid from the mouthpiece. If single acting, the volume of vacuum cylinder 4072 above vacuum piston 4074 pulls fluid from the mouthpiece. This would require some changes to either top control valve assembly 4030 or bottom control valve assembly 4040.

In operation, and during vacuum piston 4074 back stroke motion, vacuum cylinder 4072 pulls fluid and air from the mouthpiece through one of the bi-directional inlet/outlet pipes 4010a and 4010b. The fluid flows through reciprocating flow controller 4050, through a one-way valve located in top control valve assembly 4030, and into the portion of vacuum cylinder 4072 above vacuum piston 4074. On the upstroke of vacuum piston 4074, the fluid and air in the portion of vacuum cylinder 4072 above vacuum piston 4074 are pushed through top control valve assembly 4030, and the flow is directed back into the local reservoir. Air is vented to atmosphere and the fluid is again available for delivery.

Since the vacuum system shown in FIGS. 11a and 11b is double acting, as vacuum piston 4074 moves in its upstroke, fluid and air from the mouthpiece are pulled through one of the bi-directional inlet/outlet pipes 4010a and 4010b. The fluid flows through reciprocating flow controller 4050, through a one-way valve located in top control valve assembly 4030, through vacuum flow tube 4084, and into the portion of vacuum cylinder 4072 below vacuum piston 4074. The portion of vacuum cylinder 4072 below vacuum piston 4074 is then emptied on the backstroke, through vacuum flow tube 4082, with fluid and air again pushed through top control valve assembly 4030, and directed back into the local reservoir. Air is vented to atmosphere and the fluid is again available for delivery.

Reciprocating flow controller 4050 directs the fluid from delivery cylinder 4062, and the vacuum from the vacuum cylinder 4072 to one or the other bi-directional inlet/outlet pipes 4010a and 4010b, and then switch the flow direction after a specific time of operation. This creates a reciprocating fluid action within the liquid contacting chamber (LCC) of the application tray. Reciprocating flow controller 4050 is driven by linear motor 4420. The linear motion of linear motor 4420 may be converted to rotational motion in the reciprocating flow controller 4050 using technologies known in the art.

An embodiment of a hand piece according to the present invention is shown in FIGS. 12a through 12e. In this embodiment, hand piece 5000 is designed in a modular fashion, with a pumping section, vacuum section, reciprocating section, fluid storage section, and dual drive pumps to drive the pumping and vacuum sections. This embodiment allows for increased control, comfort, simplification and miniaturization of a hand held, fluidic oral care cleaning device. The invention also provides improved ergonomics, compactness, aesthetics, and portability of a fluidic hand-held system. Additionally, by utilizing multiple linear motors, sized proportionally for the delivery and vacuum pumping systems, a further reduction in size is possible, while increasing the performance and power of each individual system. The fluid flow switching system is also designed to minimize space and power requirements, while providing maximum functionality through conversion of the linear motion of a linear motor to the rotary motion required to drive a rotary flow switching disk.

FIG. 12a is a top, rear, perspective view of an embodiment of a hand piece 5000 according to the present invention. FIG. 12b is a cut-away view of the embodiment of FIG. 12a, while FIG. 12c is an exploded view of the embodiment of FIG. 12a.

The figures show that hand piece 5000 includes an outer shell 5002 with an upper and lower portion separated by a divider plate 5430. The upper portion of hand piece 5000 includes mouthpiece receptacle 5004, inlet/outlet pipes 5010a and 5010b, control valve assembly 5300, reciprocating flow controller 5200, delivery volume 5062, delivery linear motor 5420, vacuum volume 5072, and vacuum linear motor 5425. Delivery volume 5062 includes delivery piston 5064. Vacuum volume 5072 includes vacuum piston 5074.

Outer shell 5002 is shown as having a front shell piece 5002a and a rear shell piece 5002b. It is to be understood that outer shell 5002 may be a single piece.

The lower portion of hand piece 5000 includes power source 5530 and electronic controls 5535.

Delivery volume 5062 is defined as the opened volume of delivery linear motor 5420, shown here as a cylinder. Vacuum volume 5072 is defined as the opened volume of vacuum linear motor 5425.

In this embodiment, delivery linear motor 5420 and vacuum linear motor 5425 are shown configured side by side, but they can also be configured above and below. In addition, the vacuum volume 5072 is shown as larger than the delivery volume 5062. However, the vacuum volume 5072 may be smaller than the delivery volume 5062, or the volumes may be equivalent.

Delivery linear motor 5420 and vacuum linear motor 5425 can be single, double or multiple poles and may be driven by electronic control. The motors for either the vacuum or delivery systems may be moving magnet—stationary coil as shown in the figures, or moving coil—stationary magnet, or a combination of the two. The coil and magnet may be single, dual as shown, or multiple poles, as required. In this embodiment delivery piston 5064 and vacuum piston 5074 are the moving magnets for delivery linear motor 5420 and vacuum linear motor 5425. Also, the outer walls of delivery linear motor 5420 and vacuum linear motor 5425 are encompassed by the stationary coils for the delivery linear motor 5420 and vacuum linear motor 5425.

FIG. 12b shows delivery piston 5064 and vacuum piston 5074 in phase at the top of their up stroke. The pistons, however, do not have to operate in phase, or at the same frequency. Delivery piston 5064 and vacuum piston 5074 may include a durable and wear resistant material attached to the magnet piston to guide the magnet within the coil and provide the required engagement to the cylinder to create the piston/cylinder function for vacuum and delivery pressure. The pistons are driven by coordinating and changing the voltage potential between the poles to create the reciprocation action. Pulse width modulation (PWM) may be utilized to maximize LM force to the system, manage power usage, while minimizing LM heat generation. A conversation of energy system may be installed using springs and other components to be optimized for the desired frequency, stroke and force requirements.

Increased control and performance of each of the systems is also possible due to the ability to optimize the frequency, velocity, acceleration of the vacuum relative to the delivery systems, independently. The systems may be run in phase or out of phase. The vacuum system may also be run at a different frequency than the delivery system, either independent or in phase with each other. For example, the vacuum may run twice the frequency of delivery system to increase vacuum if required. The independent systems can also incorporate delays as previously described, such that the vacuum system may be initiated sometime before the delivery system and may then be disengaged sometime after the delivery system has been disengaged.

Power source 5530 is shown in the form of batteries in FIGS. 12a and 12b. The batteries could be single use or rechargeable. It is understood that power source 5530 could also be in the form of a transformer that converts alternating current (AC) to direct current (DC). In this case, hand piece 5000 will include an electric power cord, or in the form of a capacitor, charged prior to each use.

The local reservoir 5086 is defined as the volume located around the outside of the delivery linear motor 5420 and vacuum linear motor 5425, and inside outer shell 5002 between top control valve assembly 5300 and divider plate 5430. This design maximizes the use of space inside outer shell 5002, and minimizes the size of hand piece 5000.

In operation, local reservoir 5086 feeds fluid to delivery volume 5062. This allows one way flow from local reservoir 5086 to fill the delivery volume 5062 during the down stroke of delivery piston 5064. The fluid is forced out of delivery volume 5062 during the upstroke of delivery piston 5064, through a series of one-way valves located in top control valve assembly 5300. The fluid flows through reciprocating flow controller 5200, and out either of the bi-directional inlet/outlet pipes 5010a and 5010b, which are located in mouthpiece receptacle 5004 of hand piece 5000, and into the mouthpiece (not shown).

Though shown as single acting in FIGS. 12a and 12b, delivery linear motor 5420 can be single or double acting. If single acting, the fluid in of delivery volume 5062 above delivery piston 5064 delivers fluid to the mouthpiece. A double acting delivery linear motor 5420 would use the fluid in delivery volume 5062 above and below delivery piston 5064 to deliver fluid to the mouthpiece. This would require some changes to control valve assembly 5300.

The figures also show vacuum linear motor 5425 as single acting. A single acting cylinder uses the fluid in vacuum volume 5072 above vacuum piston 5074 to pull fluid from the mouthpiece. A double acting vacuum linear motor 5425 would use the fluid in vacuum volume 5072 above and below vacuum piston 5074 to pull fluid from the mouthpiece. This would require some changes to either control valve assembly 5300.

In operation, during delivery piston 5064 down stroke motion, delivery volume 5062 pulls fluid from local reservoir 5086 through one-way valves located in control valve assembly 5300, and into delivery volume 5062. On the upstroke of delivery piston 5064, the fluid in delivery volume 5062 is pushed through control valve assembly 5300, and the flow is directed through reciprocating flow controller 5200, and enters the mouthpiece through one of the bi-directional inlet/outlet pipes 5010a and 5010b.

During vacuum piston 5074 down stroke, vacuum volume 5072 pulls fluid and air from the mouthpiece through one of the bi-directional inlet/outlet pipes 5010a and 5010b. The fluid flows through reciprocating flow controller 5200, through one-way valves located in control valve assembly 5300, and into vacuum volume 5072. On the upstroke of vacuum piston 5074, the fluid and air in vacuum volume 5072 are pushed through control valve assembly 5300, and the flow is directed back into the top of local reservoir 5086. Air is vented to atmosphere and the fluid is again available for delivery.

In embodiments with reciprocating flow, reciprocating flow controller 5200 directs the fluid from delivery volume 5062, and the vacuum from the vacuum volume 5072 to one or the other bi-directional inlet/outlet pipes 5010a and 5010b, and then switch the flow direction after a specific time of operation. This creates a reciprocating fluid action within the fluid contacting chamber (LCC) of the application tray. Reciprocating flow controller 5200 is driven delivery linear motor 5420 and vacuum linear motor 5425. The linear motion of either linear motor may be converted to rotational motion in the reciprocating flow controller 5200 using technologies known in the art.

FIG. 12d is a top, rear, exploded view of the local reservoir 5086, reciprocating flow controller 5200, control valve assembly 5300, and mouthpiece receptacle 5004 of hand piece 5000. FIG. 12e is a bottom, rear, exploded view of the same sections of hand piece 5000. Reciprocating flow controller 5200 has flow diverter disk 5210, position adjuster 5220, and base 5240. Base 5240 has base ports 5242 and 5244 which traverse through base 5240, and flow channels 5246 and 5248 located on the bottom side of base 5240. Flow diverter disk 5210 and position adjuster 5220 are disposed between base 5240 and mouthpiece receptacle 5004, and are in the form of gears which may be driven by the motion of delivery piston 5064. Flow diverter disk 5210 has panel 5216 for diverting fluid flow, and flow channels 5212 and 5214.

In operation, incoming fluid, such as fluid in tube 312 of FIG. 1, enters reciprocating flow controller 5200 through base port 5244. Depending on the position of reciprocating flow controller 5200, the fluid flows through either flow channel 5212 of 5214, and exits reciprocating flow controller 5200 through either inlet/outlet pipe 5010a or 5010b of mouthpiece receptacle 5004. Returning fluid, such as fluid in tube 334 of FIG. 1, reenters reciprocating flow controller 5200 through either inlet/outlet pipe 5010a or 5010b of mouthpiece receptacle 5004. Depending on the position of reciprocating flow controller 5200, the fluid flows through either flow channel 5212 or 5214, and exits reciprocating flow controller 5200 through base port 5242, such as fluid in tube 322 of FIG. 1.

Reciprocation of fluid in application tray 100 of FIG. 1 is achieved by switching reciprocating flow controller 5200 between a first position and a second position.

It has been found that the width of panel 5216 relative to the diameters of base ports 5242 and 5244 is critical to the performance of reciprocating flow controller 5200. If the width of panel 5216 is equal to or greater than any of the diameters, then one or more of base ports 5242 and 5244 may be blocked, or isolated, during part of the reciprocation, resulting in suboptimal performance or device failure. A channel may be located in panel 5216 to avoid this condition.

FIGS. 12d and 12e also show exploded views of control valve assembly 5300. Control valve assembly 5300 includes first plate 5320, second plate 5340, third plate 5360, and fourth plate 5390, as well as first gasket 5310, second gasket 5330, third gasket 5350, and fourth gasket 5380. First gasket 5310 is disposed between base 5240 of reciprocating flow controller 5200 and first plate 5320. Second gasket 5330 is disposed between first plate 5320 and second plate 5340. Third gasket 5350 is disposed between second plate 5340 and third plate 5360. Fourth gasket 5380 is disposed between third plate 5360 and fourth plate 5390.

First gasket 5310 has ports 5312 and 5314 which traverse through first gasket 5310. First plate 5320 has ports 5322 and 5324 which traverse through first plate 5320, and flow channel 5326 located on the bottom side of first plate 5320.

Second gasket 5330 has ports 5332 and 5336 which traverse through second gasket 5330, and one-way flap valve 5334. Second plate 5340 has ports 5342, 5344, and 5346 which traverse through second plate 5340, and flow channels 5347 and 5348 located on the bottom side of second plate 5340.

Third gasket 5350 has ports 5352, 5354, 5356 and 5358, which traverse through third gasket 5350. Third plate 5360 has ports 5362, 5364, 5365, 5366, 5367, and 5368 which traverse through third plate 5360.

Fourth gasket 5380 has ports 5384 and 5386 which traverse through fourth gasket 5380, and one-way flap valves 5382, 5385, 5387, and 5388. Fourth plate 5390 has ports 5392, 5394, 5395, 5397, and 5398 which traverse through fourth plate 5390, and grooves 5391 and 5393 located on the bottom side of fourth plate 5390.

Delivery linear motor 5420 and vacuum linear motor 5425 are disposed between fourth plate 5390 and delivery divider plate 5430. The top 5421 of delivery linear motor 5420 fits into groove 5391 of fourth plate 5390, while the bottom 5422 of delivery linear motor 5420 fits into hole 5432 of delivery divider plate 5430. The top 5426 of vacuum linear motor 5425 fits into groove 5393 of fourth plate 5390, while the bottom 5427 of vacuum linear motor 5425 fits into hole 5434 of delivery divider plate 5430. As a reminder, local reservoir 5086 is defined as the volume located around the outside of the delivery linear motor 5420 and vacuum linear motor 5425, and inside outer shell 5002 between fourth plate 5390 and divider plate 5430.

In operation, during delivery piston 5064 down stroke, fluid from local reservoir 5086 passes through port 5395 of fourth plate 5390, flap valve 5385 of fourth gasket 5380, port 5365 of third plate 5360, and port 5354 of third gasket 5350. The fluid then passes along flow channel 5347 of second plate 5340, and flows through port 5364 of third plate 5360, port 5384 of fourth gasket 5380, port 5394 of fourth plate 5390, and arrives in delivery volume 5062.

On the upstroke of delivery piston 5064, the fluid in delivery volume 5062 is pushed through port 5394 of fourth plate 5390, port 5384 of fourth gasket 5380, port 5364 of third plate 5360, port 5354 of third gasket 5350, port 5344 of second plate 5340, flap valve 5334 of second gasket 5330, port 5324 of first plate 5320, and port 5314 of first gasket 5310. The flow is then directed through reciprocating flow controller 5200 via channel 5248 of base 5240, passing through base port 5244 and then either flow channel 5212 or 5214 of flow diverter disk 5210, exiting reciprocating flow controller 5200 and entering the mouthpiece through one of the bi-directional inlet/outlet pipes 5010a and 5010b.

One-way flap valve 5385 on fourth gasket 5380, and one-way flap valve 5334 on second gasket 5330 insure the one-way flow of fluid from local reservoir 5086 to delivery volume 5062 during delivery piston 5064 down stroke, and one-way flow from delivery volume 5062 to reciprocating flow controller 5200 during delivery piston 5064 upstroke.

During vacuum piston 5074 down stroke, fluid from the mouthpiece is pulled through one of the bi-directional inlet/outlet pipes 5010a and 5010b, and is directed through reciprocating flow controller 5200 through either flow channel 5212 or 5214 of flow diverter disk 5210, and passes through base port 5242 of base 5240. The fluid leaves reciprocating flow controller 5200 after flowing through channel 5246 of base 5240. The fluid passes through port 5312 of first gasket 5310, port 5322 of first plate 5320, port 5332 of second gasket 5330, port 5342 of second plate 5340, port 5352 of third gasket 5350, port 5362 of third plate 5360, one-way flap valve 5382 of fourth gasket 5380, and port 5392 of fourth plate 5390, and arrives in vacuum volume 5072.

On the upstroke of vacuum piston 5074, the fluid in delivery volume 5062 is pushed through port 5398 of fourth plate 5390, one-way flap valve 5388 of fourth gasket 5380, port 5368 of third plate 5360, and port 5358 of third gasket 5350. The fluid flows through channel 5348 of plate 5340, into port 5336 of second gasket into port 5326 in first plate, then through port 5346 of second plate, through port 5356 of third gasket, through port 5356 in third plate, through port 5386 in fourth gasket, and arrives in local reservoir 5086

One-way flap valves 5382, 5387 and 5388 of fourth gasket 5380 insure the one-way flow of fluid from reciprocating flow controller 5200 to vacuum volume 5072 during vacuum piston 5074 down stroke, and one-way flow from vacuum volume 5072 to local reservoir 5086 during vacuum piston 5074 upstroke.

What is claimed is:

1. A system for providing a beneficial effect to the oral cavity of a mammal, comprising:
means for directing a fluid onto a plurality of surfaces of said oral cavity, said fluid effective to provide said beneficial effect; and
a hand-held device suitable for providing said fluid to said means for directing said fluid onto said plurality of surfaces of said oral cavity, said hand-held device comprising:
means for providing reciprocation of said fluid over said plurality of surfaces,
means for controlling said reciprocation of said fluids,
means for conveying said fluid through said system,
a reservoir for containing said fluid,
means for driving said means for providing said reciprocation of said fluids; and
a linear motor for driving said system.

2. The system of claim 1 wherein said controlling means comprises means for conveying said fluid to and from said means for directing said fluid onto said plurality of surfaces of said oral cavity.

3. The system of claim 1 comprising means for attaching said hand-held device to said means for directing said fluid onto said plurality of surfaces of said oral cavity.

4. The system of claim 1 wherein said means for providing reciprocation of said fluid over said plurality of surfaces, said means for controlling said reciprocation of said fluids, said means for conveying said fluid through said system, said reservoir for containing said fluid, said means for driving said means for providing said reciprocation of said fluids and said linear motor for driving said system are contained within a housing.

5. The system of claim 1 wherein said means for directing said fluid onto said plurality of surfaces of said oral cavity is removably or fixedly attached to said hand-held device.

6. The system of claim 4 wherein said means for directing said fluid onto said plurality of surfaces of said oral cavity is removably or fixedly attached to said housing.

7. A hand-held device suitable for providing a fluid to means for directing said fluid onto a plurality of surfaces of an oral cavity, said fluid effective to provide a beneficial effect to said oral cavity, said hand-held device comprising:
means for providing reciprocation of said fluid over said plurality of surfaces,
means for controlling said reciprocation of said fluids,
means for conveying said fluid through said system,
a reservoir for containing said fluid,
means for driving said means for providing said reciprocation of said fluids; and
a linear motor for driving said device.

8. The device of claim 7 wherein said controlling means comprises means for conveying said fluid to and from said means for directing said fluid onto said plurality of surfaces of said oral cavity.

9. The device of claim 7 comprising means for attaching said hand-held device to said means for directing said fluid onto said plurality of surfaces of said oral cavity.

10. The device of claim 7 wherein said means for providing reciprocation of said fluid over said plurality of surfaces, said means for controlling said reciprocation of said fluids, said means for conveying said fluid through said system, said reservoir for containing said fluid, said means for driving said means for providing said reciprocation of said fluids and said linear motor for driving said device are contained within a housing.

11. The device of claim 7 wherein said means for directing said fluid onto said plurality of surfaces of said oral cavity is removably or fixedly attached to said hand-held device.

12. The system of claim 10 wherein said means for directing said fluid onto said plurality of surfaces of said oral cavity is removably or fixedly attached to said housing.

13. The system of claim 1 comprising multiples of said linear motor.
